(19) United States
(12) Patent Application Publication
(10) Pub. No.: US 2013/0066801 A1
(43) Pub. Date: Mar. 14, 2013

(54) OPTION SPREAD MIDRANGE PROCESSING

(71) Applicant: Michael Phillips, Claymont, DE (US)

(72) Inventor: Michael Phillips, Claymont, DE (US)

(73) Assignee: Power Financial Group, Inc., Wilmington, DE (US)

(21) Appl. No.: 13/227,715

(22) Filed: Sep. 8, 2011

(51) Int. Cl. G06Q 40/00

(52) U.S. Cl. 705/36 R; 705/37

(57) ABSTRACT

Midrange values, which may be, for example, midpoint values, may be derived and provided for use in identifying spread opportunities. A first midrange value disposed between a bid price and a ask price is derived for the first financial instrument. A second midrange value disposed between a bid price and a ask price is derived for a second financial instrument. A computing system then derives from the first and second midrange values a midrange spread value representing a difference between the first and second midrange values. Information identifying the first financial instrument including the first midrange value, information identifying the second financial instrument including the second midrange value, and the midrange spread value are communicated for display.

### BACKGROUND

Systems and methods have been developed that allow individuals to use their own search parameters to search for financial instruments such as, for example, stocks, bonds, stock options, and option strategies such as covered calls, covered puts, spreads, etc. For example, U.S. Pat. No. 6,049,783 entitled “Interactive Internet Analysis Method,” U.S. patent application Ser. No. 10/607,418 filed on filed Jun. 26, 2003 and entitled “Improved System And Method For Analyzing And Searching Financial Instrument Data,” and U.S. patent application Ser. No. 09/676,374 filed on Oct. 29, 2000 and entitled “System and Method for Analyzing and Searching Financial Instrument Data,” the contents of all of which are hereby incorporated by reference in their entirety, describe systems and methods for searching for and implementing stock option strategies.

While existing systems offer useful functionality, Applicants have sought to develop systems that identify option investments with greater financial return.

### SUMMARY

According to one aspect of the disclosed embodiments, midrange values, which may be, for example, midpoint values, may be derived and provided for use in identifying spread opportunities. In one illustrative embodiment, financial data regarding a plurality of financial instruments such as, for example, stocks and stock options, are comprised in a data store. A computing system uses the financial data for a first financial instrument in the data store to derive a first midrange value disposed between a bid price and a ask price for the first financial instrument. The computing system uses the financial data for a second financial instrument in the data store to derive a second midrange value disposed between a bid price and a ask price. The computing system then derives from the first and second midrange values a midrange spread value representing a difference between the first and second midrange values. Information identifying the first financial instrument including the first midrange value, information identifying the second financial instrument including the second midrange value, and the midrange spread value are communicated for display. The midrange spread value and first and second midrange values for the spread provide enhanced information that may be used in determining whether to enter a spread.

According to another aspect of the disclosed embodiments, midrange values may be provided for use in evaluating existing spread positions. In one example scenario, the computing system uses the financial data in the data store to identify a first spread comprising a first financial instrument and a second financial instrument where the spread has a first strike differential representing a difference in strike prices between the first financial instrument and the second financial instrument. The computing system uses the financial data for the first financial instrument to identify a first midrange value disposed between the bid and the ask price. The computing system uses the financial data for the second financial instrument to identify a second midrange value disposed between a bid price and an ask price. Using the first and second midrange values, the computing system then determines a first spread midrange difference value that represents a difference between the first and second midrange values. The computing system may further derive a first strike price differential representing a difference between a strike price for the first financial instrument and a strike price for the second financial instrument. The derived information may be available for use in searching for spread opportunities. For example, in response to a request, the system may search for spreads with a strike price differential somewhat similar or less than or greater than the first strike price differential. The system may identify one or more spreads with a strike price differential somewhat similar to or less than or greater than the first strike price differential, where the spreads comprise a third financial instrument and a fourth financial instrument. The computing system then derives using the financial data for the third financial instrument a third midrange value disposed between a bid price and an ask price. The computing system derives using the financial data for the fourth financial instrument a fourth midrange value disposed between a bid price and an ask price. Using the third and fourth midrange values, the computing system generates a second spread midrange difference value representing a difference between the third and fourth midrange values. The computing system then communicates identifying information for the first and second spreads including midrange values for the financial instruments comprised in the spreads and the midrange values for the spreads themselves.

According to another aspect of illustrative embodiments, the disclosed systems and methods may allow for receiving inputs designating an expected movement in price of an underlying financial instrument. The expected movement in price of the underlying financial instrument is then used to derive midrange values for financial instruments and spreads. In one example scenario, the computing system uses the financial data in the data store to identify a first spread comprising a first financial instrument and a second financial instrument where the spread has a first strike differential representing a difference in strike prices between the first financial instrument and the second financial instrument. The system then identifies an estimated price movement for a financial instrument. This estimated price movement may be received as a result of user input. The computing system uses the financial data for the first financial instrument and the estimated price movement to identify a first midrange value disposed between the bid and the ask price. The computing system uses the financial data for the second financial instrument and the estimated price movement to identify a second midrange value disposed between a bid price and an ask price. Using the first and second midrange values, the computing system then determines a first spread midrange difference value that represents a difference between the first and second midrange values. The computing system may further derive a first strike price differential representing a difference between a strike price for the first financial instrument and a strike price for the second financial instrument. The derived information may be available for use in searching for spread opportunities. For example, in response to a request, the system may search for spreads with a strike price differential somewhat similar or less than or greater than the first strike price differential. The system may identify one or more spreads with a strike price differential somewhat similar to or less than or greater than the first strike price differential, where the spreads comprise a third financial instrument and a fourth financial instrument. The computing system then derives using the financial data for the third financial instrument a third midrange value disposed between a bid price and an ask price. The computing system derives using the financial data for the fourth financial instrument a fourth midrange value disposed between a bid price and an ask price. Using the third and fourth midrange values, the computing system generates a second spread midrange difference value representing a difference between the third and fourth midrange values. The computing system then communicates identifying information for the first and second spreads including midrange values for the financial instruments comprised in the spreads and the midrange values for the spreads themselves.

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter. Other features are described below.

### BRIEF DESCRIPTION OF THE DRAWINGS

FIG. 1 illustrates a block diagram depicting a client/server communication system;

FIGS. 2A-K depict a flow chart of exemplary methods for searching for investment opportunities;

FIG. 3 depicts an exemplary user interface that may be generated in connection with the methods depicted in FIGS. 2A-K;

FIG. 4 depicts an exemplary user interface that may be generated in connection with the methods depicted in FIGS. 2A-K;

FIGS. 5A-E depict an exemplary user interface that may be generated in connection with the methods depicted in FIGS. 2A-K;

FIG. 6 depicts an exemplary user interface that may be generated in connection with the methods depicted in FIGS. 2A-K;

FIG. 7 depicts an exemplary user interface that may be generated in connection with the methods depicted in FIGS. 2A-K;

FIGS. 8A-B depict an exemplary user interface that may be generated in connection with the methods depicted in FIGS. 2A-K;

FIG. 9 depicts an exemplary user interface that may be generated in connection with the methods depicted in FIGS. 2A-K;

FIGS. 10A-B depict an exemplary user interface that may be generated in connection with the methods depicted in FIGS. 2A-K;

FIG. 11 depicts a block diagram of a computing system for use in a system such as is depicted in FIG. 1.

### DETAILED DESCRIPTION OF ILLUSTRATIVE EMBODIMENTS

### Overview

For many financial instruments, the separation between bid price, which may be the price at which a financial instrument may be sold to a market, and ask price, which may be the price at which a financial instrument may be purchased from a market, can be substantial. The wide separation between bid and ask prices for financial instruments presents opportunities for investors to increase potential profits from their investments by receiving prices for execution of trades disposed between the bid and ask prices for the financial instruments. For example, in an example scenario, if a stock or option is purchased at the market ask price, the subsequent return on that stock or option if it also sold at the market bid price may be 1 percent. For a purchase of the same stock or option at a midrange price rather than the market ask price, and subsequently sold at a midrange price rather than the market bid price, the potential profit may be 3 percent.

Applicants disclose systems and methods that generate midrange values for option spreads and allow for searching and selecting option investments using midrange values. For example, in one illustrative embodiment, financial data regarding a plurality of financial instruments such as, for example, stocks and stock options, are comprised in a data store. A computing system uses the financial data for a first financial instrument in the data store to derive a first midpoint value disposed between a bid price and a ask price for the first financial instrument. The computing system uses the financial data for a second financial instrument in the data store to derive a second a second midpoint value disposed between a bid price and a ask price. The computing system then derives from the first and second midpoint values a midrange spread value disposed between the first and second midpoint values. Information identifying the first financial instrument including the first midpoint value, information identifying the second financial instrument including the second midpoint value, and the midrange spread value are communicated for display. The midrange spread value and midpoint values for the spread provide enhanced information that may be used in determining whether to enter a spread.

The disclosed systems may be employed to identify and compare option spreads for any type of spread investment. A call option may be defined as an option contract that gives the holder the right to buy a certain quantity (usually 100 shares) of an underlying security, such as a stock, from the writer of the option, at a specified price (the strike price) up to a specified date (the expiration date). A put option may be defined as an option contract that gives the holder the right to sell a certain quantity of an underlying security to the writer of the option, at the strike price up to the expiration date. A basic spread trade generally comprises purchasing a first stock option and selling a second stock option distinctly different from the first stock option. Non-limiting examples of spread trades include bull put spread, bear call spread, bear call credit spread, bear put debit spread, bull call debit spread, bull put credit spread, butterfly spread, calendar spread, collar spread, straddle spread and strangle spread.
A bull put spread may be a spread strategy wherein a first put option is purchased and a second put option is sold, first put option and second put option generally having the same expiration date.
A bear call spread may be a spread strategy wherein a call option with a higher striking price is purchased and a call option with a lower striking price is sold, purchased higher strike price call option and sold loser strike price call option generally having the same expiration date.
A bear call credit spread strategy may be a bearish combination investment strategy where the investor realizes a profit by making cash from a net credit formed by the difference between the premium earned on a sold call and the premium paid for a bought call. While the stock goes down, the investor keeps the net difference in premiums.
A bear put debit spread strategy may be a bearish combination investment strategy where the investor realizes a profit when the value of a long put increases as the stock price drops. The sold put helps to offset the cost of the long put and also provides a finite maximum risk level.
A bull call debit spread strategy may be a bullish combination investment strategy where the investor realizes a profit when the value of a long call increases as the stock price rises. The sold call helps to offset the cost of the long call and also provide a finite maximum risk level.
A bull put credit spread strategy may be a bullish combination investment strategy where the investor realizes a profit by making cash from a net credit formed by the difference between the premium earned on a sold put and the premium paid for a bought put. While the stock goes up, the investor keeps the net difference in premiums.
A butterfly spread may be a spread strategy that involves combining a bull put spread and a bear call spread wherein four striking prices are involved, with the lower two being utilized in the bull spread and the higher two in the bear spread.
A calendar spread may be a spread strategy in which a short-term option is sold and a longer-term option is purchased, wherein each option has the same strike price.
A collar spread may be a spread strategy comprising of a standard covered call, wherein a call option is written and the underlying stock is purchased, and purchasing of a put option in the underlying company for downside protection.
A straddle spread may be a spread strategy wherein an equal number of puts and calls having the same terms are either purchased or sold.
A strangle spread may be a spread strategy involving a put option and a call option with the same expiration dates and different strike prices.

The illustrative systems and methods disclosed herein generate and provide midrange values for option spreads. The midrange values may be used to assist in evaluating spreads and spread strategies.

Example Computing Arrangement

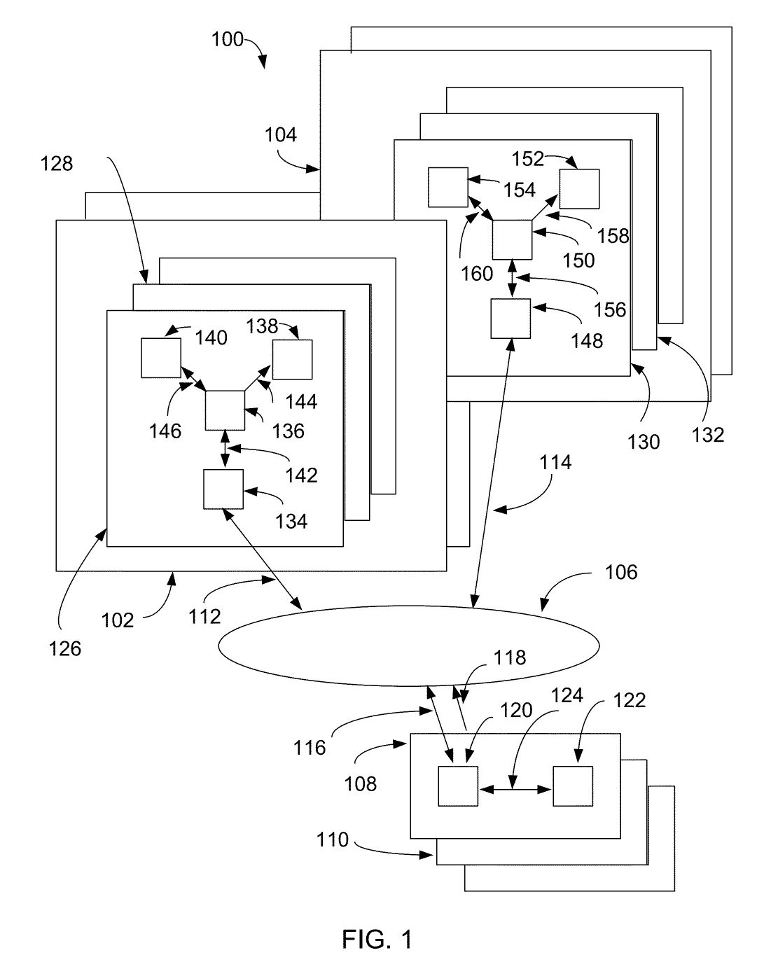

FIG. 1 illustrates a block diagram depicting an exemplary client/server communication system that may be suitable for use in executing the disclosed methods. A communication system 100 includes a multiplicity of networked regions with a sampling of regions denoted as a network region 102, a network region 104, a global network 106 and a multiplicity of servers including an exemplary server device 108 and an exemplary server device 110.

It will be understood by those skilled in the art that communication system 100 may take many different forms. Non-limiting examples of forms for communication system 100 include local area networks (LANs), wide area networks (WANs), wired telephone networks, cellular telephone networks or any other network supporting data communication between respective entities via hardwired or wireless communication networks.

Network region 102 and network region 104 represent networks that are configured to communicate information between a designated set of computers or within geographic area. For example, network regions 102, 104 may be local area networks (LANs) or similarly sized networks. Non-limiting examples of representations for the geographical areas for the networked regions may include postal zip codes, telephone area codes, states, counties, cities and countries. Elements within network region 102 and 104 may operate to communicate with external elements within other networked regions or within elements contained within the same network region.

Global network 106 may be any network that operates to communicate information between geographically diverse computing systems and networks. For example, in an example embodiment, global network 106 may be or comprise the Internet.

Server devices 108 and 110 execute software instructions, store information, support database operations and communicate with other networked elements. Non-limiting examples of software and scripting languages which may be executed on server devices 108 and 110 include, for example C, C++, C#, .asp and Java.

Network region 102 may operate to communicate bi-directionally with global network 106 via a communication channel 112. Network region 104 may operate to communicate bi-directionally with global network 106 via a communication channel 114. Server device 108 may operate to communicate bi-directionally with global network 106 via a communication channel 116. Server device 110 may operate to communicate bi-directionally with global network 106 via a communication channel 118. Network regions 102 and 104, global network 106 and server devices 108 and 110 may operate to communicate with each other and with every other networked device located within communication system 100.

In an example embodiment, server device 108 includes a networking device 120 and a server 122. Networking device 120 may operate to communicate bi-directionally with global network 106 via communication channel 116 and with server 122 via a communication channel 124. Server 122 may operate to execute software instructions and store information.

Network region 102 includes a multiplicity of clients with a sampling denoted as a client 126 and a client 128. Client 126 includes a networking device 134, a processor 136, a GUI 138 and an interface device 140. Non-limiting examples of devices for GUI 138 include monitors, televisions, cellular telephones, smartphones and PDAs (Personal Digital Assistants). Non-limiting examples of interface device 140 include pointing device, mouse, trackball, scanner and printer. Networking device 134 may communicate bi-directionally with global network 106 via communication channel 112 and with processor 136 via a communication channel 142. GUI 138 may receive information from processor 136 via a communication channel 144 for display to a user for viewing. Interface device 140 may operate to send control information to processor 136 and to receive information from processor 136 via a communication channel 146.

Network region 104 includes a multiplicity of clients with a sampling denoted as a client 130 and a client 132. Client 130 includes a networking device 148, a processor 150, a GUI 152 and an interface device 154. Non-limiting examples of devices for GUI 152 include monitors, televisions, cellular telephones, smartphones and PDAs. Non-limiting examples of interface device 140 include pointing devices, mousse, trackballs, scanners and printers. Networking device 148 may communicate bi-directionally with global network 106 via communication channel 114 and with processor 150 via a communication channel 156. GUI 152 may receive information from processor 150 via a communication channel 158 for display to a user for viewing. Interface device 154 may operate to send control information to processor 150 and to receive information from processor 150 via a communication channel 160.

For example, consider the case where a user interfacing with client 126 may desire to execute a networked application. A user may enter the IP (Internet Protocol) address for the networked application using interface device 140. The IP address information may be communicated to processor 136 via communication channel 146. Processor 136 may then communicate the IP address information to networking device 134 via communication channel 142. Networking device 134 may then communicate the IP address information to global network 106 via communication channel 112. Global network 106 may then communicate the IP address information to networking device 120 of server device 108 via communication channel 116. Networking device 120 may then communicate the IP address information to server 122 via communication channel 124. Server 122 may receive the IP address information and after processing the IP address information may communicate return information to networking device 120 via communication channel 124. Networking device 120 may communicate the return information to global network 106 via communication channel 116. Global network 106 may communicate the return information to networking device 134 via communication channel 112. Networking device 134 may communicate the return information to processor 136 via communication channel 142. Processor 136 may communicate the return information to GUI 138 via communication channel 144. User may then view the return information on GUI 138.

Option Spread Processing

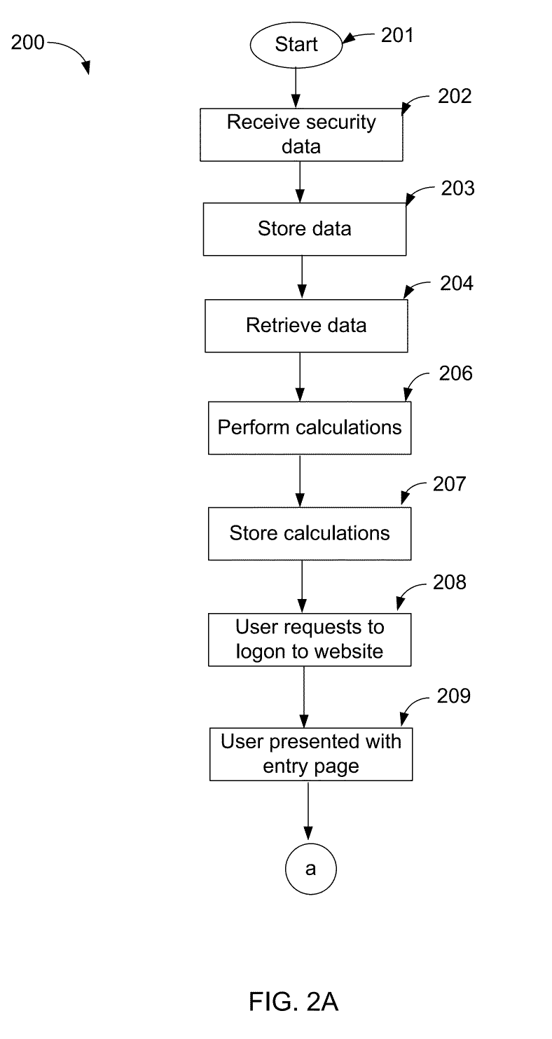

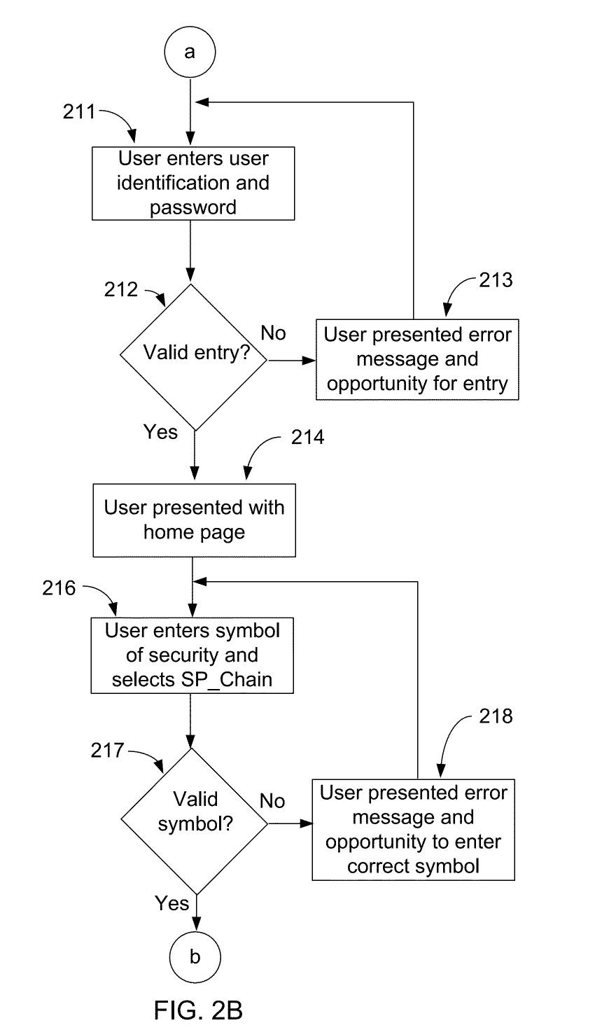

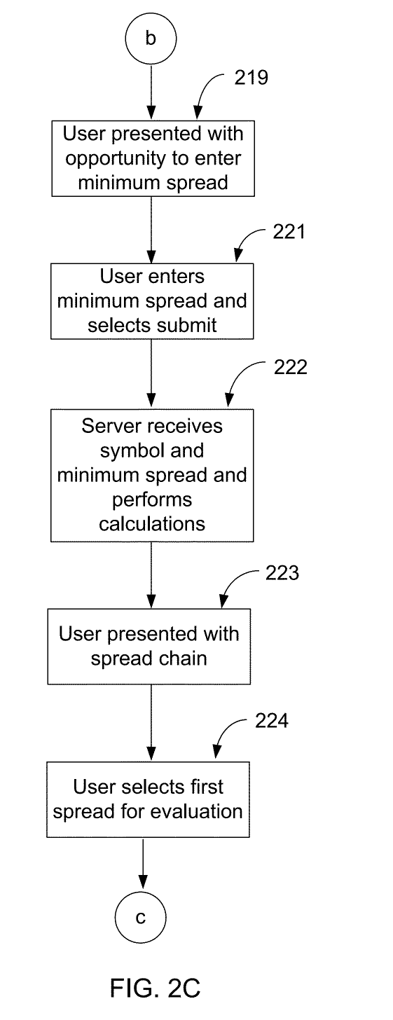

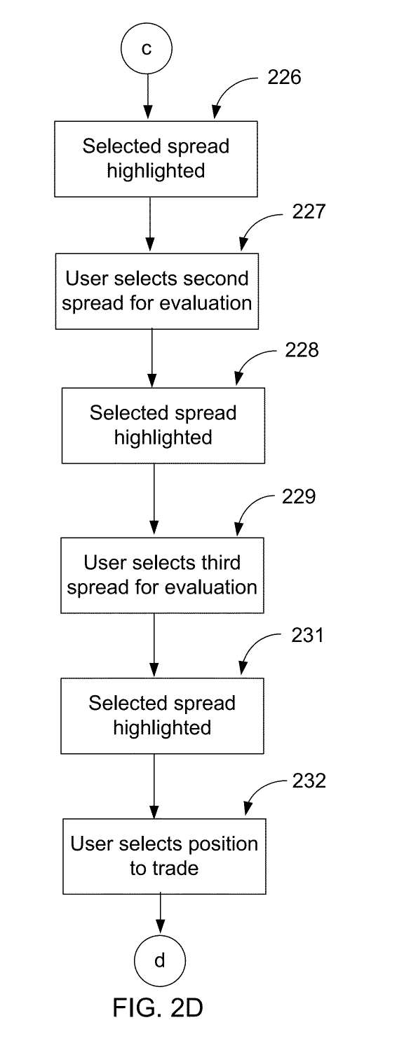

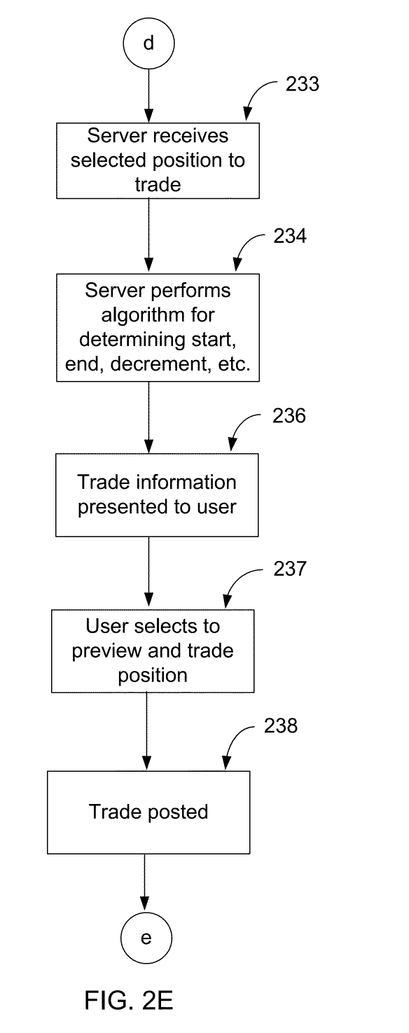

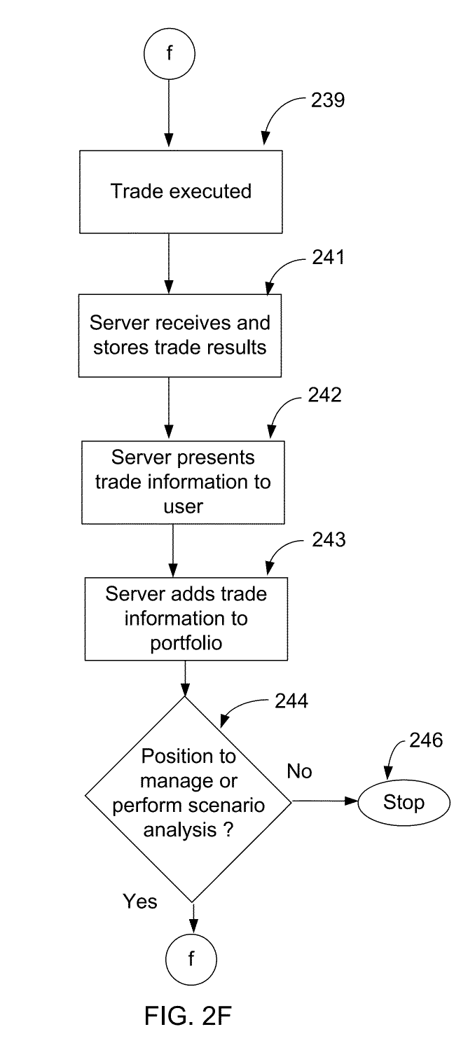

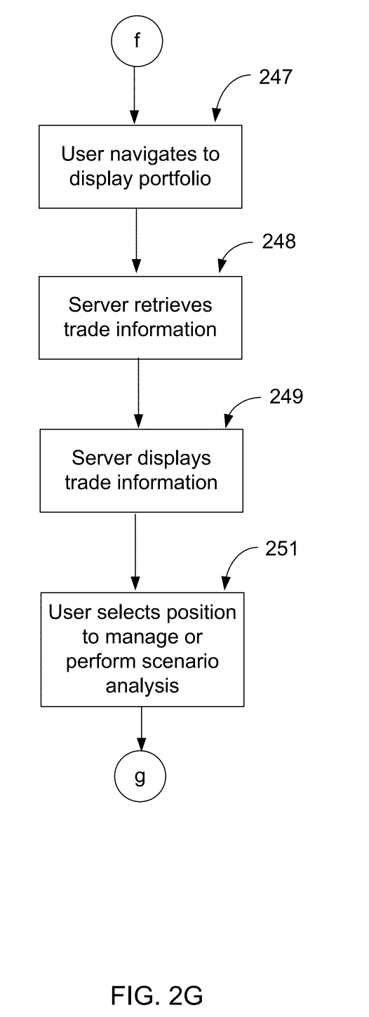

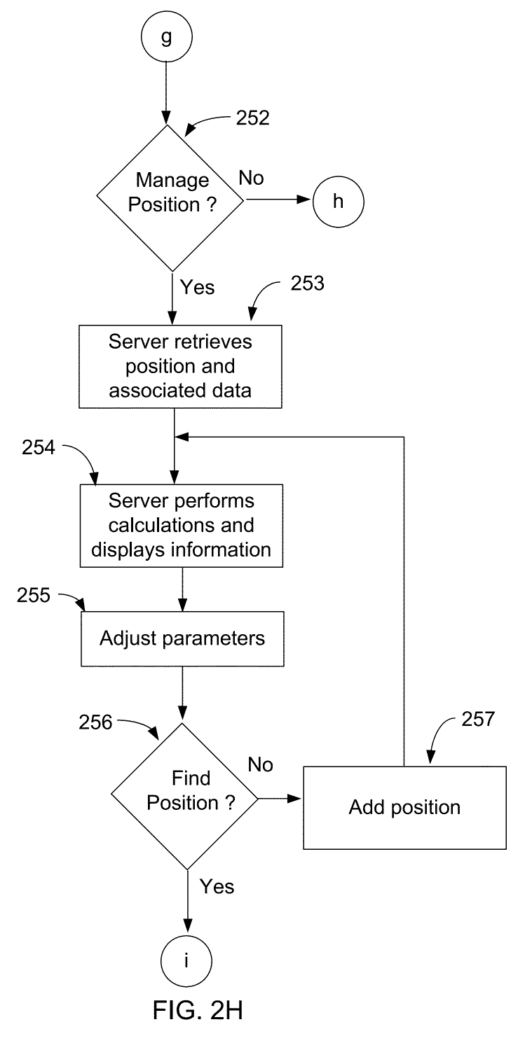

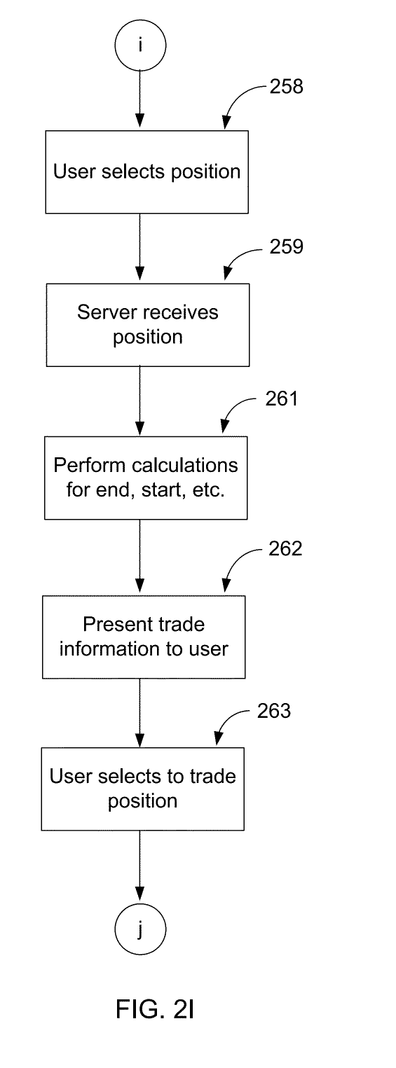

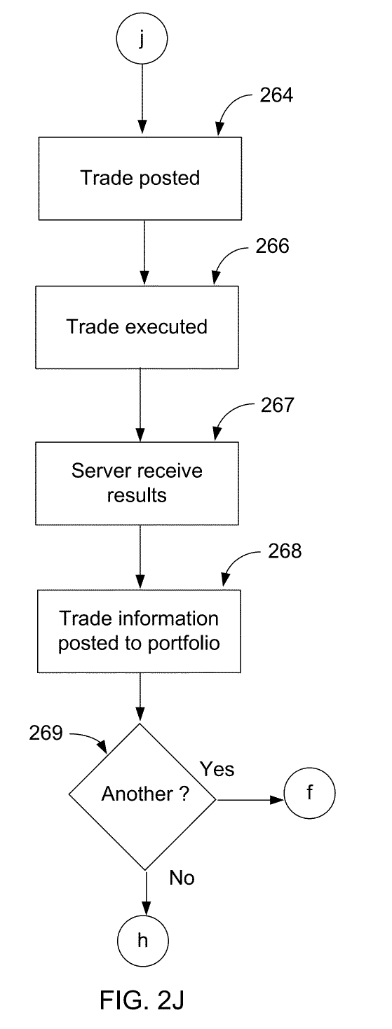

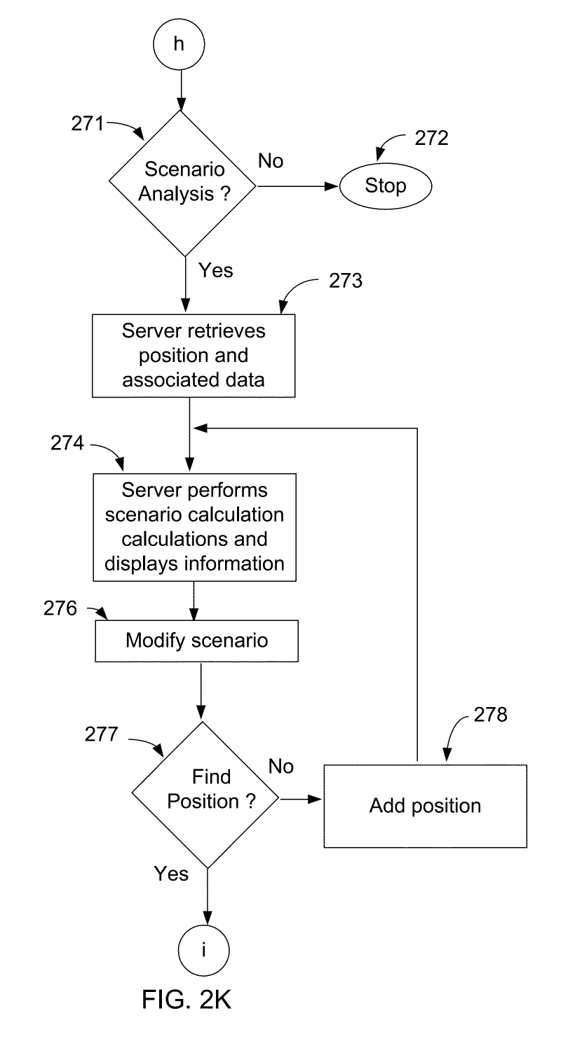

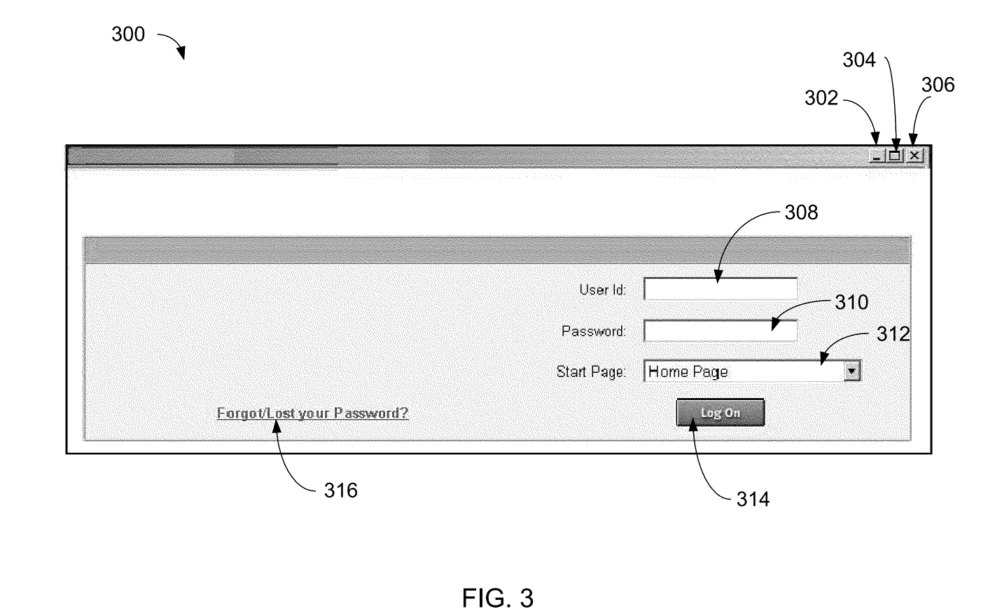

FIG. 2 is a flowchart of example processes performed by an illustrative system such as that depicted in FIG. 1 for processing requests for option investments. FIGS. 2A-K illustrate an exemplary method 200 for interaction of the elements of communication system 100 (FIG. 1) and information displays as described with reference to example FIGS. 3-10 to provide option spread processing.

Processing begins at step 201 (FIG. 2A).

At step 202, a server (e.g. server device 108 (FIG. 1)) may receive information relating to financial instruments via a network (e.g. global network 106 (FIG. 1)). For example, the server may receive market data and relevant research information relating to financial instruments such as, for example, stocks, stock options, and spreads. Non-limiting examples of information received include a type of security (e.g., stock, option, stock option, stock option spread), bid price, ask price, last price, expiration date, and exercise price. Additionally, as part of receiving the information, the server may calculate various related information relevant to the received financial information. The information that is received/and or calculated may be information such as is described in U.S. Pat. No. 6,049,783 entitled “Interactive Internet Analysis Method,” U.S. patent application Ser. No. 10/607,418 filed on filed Jun. 26, 2003 and entitled “Improved System And Method For Analyzing And Searching Financial Instrument Data,” the contents of which are hereby incorporated by reference in its entirety.

At step 203, the server (e.g. server device 108 (FIG. 1)) stores the received security-associated information. For example, the server may store the received security request information in computing memory such as RAM and may manage the information using database software.

At step 204, the server (e.g. server device 108 (FIG. 1)) retrieves previously stored security-associated information. The server may retrieve the information in response to a request. For example, in the scenario wherein a request is received for spread investment options related to a particular stock, the server retrieves stock and option data related to the stock identified in the request.

At step 206, the server (e.g. server device 108 (FIG. 1)) performs calculations for retrieved security-associated information. For example, in an example scenario, the server may calculate midrange values for options related to a particular stock. The midrange values represent a price between the bid and ask price for the particular option. In a particular scenario, the midrange value may be a midpoint value representing the midpoint between the bid and ask price. The server may also calculate midranges value for spreads comprised of options for a particular stock. A midrange value for a spread may represent a value between the midrange values for the options comprised in the particular spread. In an illustrative embodiment, the calculations that are performed may further comprise calculating potential returns associated with a particular option or option spread. Still further, the processing may comprise calculating an associated risk/reward.

At step 207, the server (e.g. server device 108 (FIG. 1)) stores the results of the calculations for the financial instruments.

At step 208, a user (not shown) may request access to a website associated with the server (e.g. server device 108 (FIG. 1)). The request is received at the server (e.g. server device 108 (FIG. 1)).

At step 209, the server communicates information for creating a web page with which the user may log-in so as to access financial information. The information communicated by the server may information for creating a user interface such as that show in FIG. 3. Referring to FIG. 3, an example user interface for entering login-in information is depicted. As shown, a user may enter user identification information into a user identification input box 308 and user password information into a user password input box 310. A user that is not able to recall or remember a password may select a password recovery selection 316. A drop-down box 312 allows a user to enter a particular functionality that the user wishes to initially access. For example, a user may wish to initially access functionality for analyzing option chains and may select to display such information using drop-down box 312. The user may then select a submit button 314 which causes the entered information to be communicated to the appropriate server. The example display offers various navigation tools that are typically provided in graphical user interfaces. For example, a display 300 may further comprise a display minimize button 302 for minimizing display 300, a display maximize button 304 for maximizing display 300, and a display close button 306 for closing the display.

Referring back to FIG. 2B, at step 211, the user enters information into the user interface and the information is received at a server. For example, the user may enter information via interface device 140 (FIG. 1) and the information communicated to server 122 (FIG. 1) of server device 108 (FIG. 1) via communication channel 146 (FIG. 1), processor 136 (FIG. 1), communication channel 142 (FIG. 1), networking device 134 (FIG. 1), communication channel 112 (FIG. 1), global network 106 (FIG. 1), communication channel 116 (FIG. 1), networking device 120 (FIG. 1) and communication channel 124 (FIG. 1).

At step 212, server 122 (FIG. 1) determines whether the user identification and password information entered by user via interface device 140 (FIG. 1) is valid.

For an invalid submission of information at step 213, the server communicates an error message and a prompt to submit valid information. Processing then proceeds to step 211.

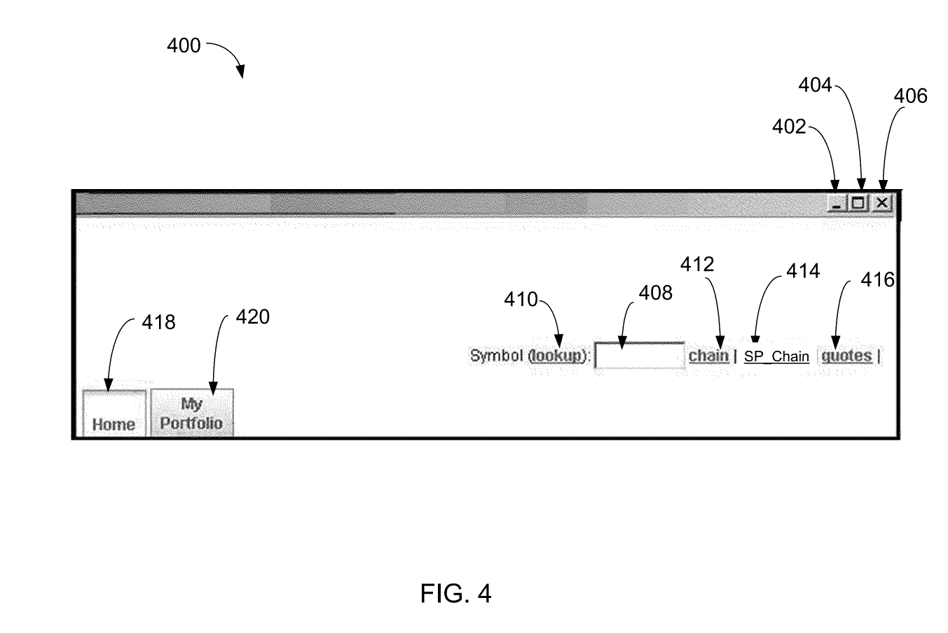

If at step 212, server 122 determines an invalid input value, at step 214, server 122 communicates a page by which a user may interface with the system. For example, user may be presented with a web page as depicted in FIG. 4. Referring to FIG. 4, a user interface screen depicts entering a request to search for investment opportunities for a particular instrument such as a stock option. A symbol information selection 410 may operate to provide a mechanism for retrieval and display of information related to a financial instrument entered in a symbol input box 408. An option chain selection 412 may operate to provide a mechanism for retrieval and display of an option chain for a financial instrument entered in symbol input box 408. A spread chain selection 414 may operate to provide a mechanism for retrieval and display of a spread chain for a financial instrument entered in symbol input box 408. A quotes selection 416 may operate to provide a mechanism for retrieval of quote information related to a financial instrument entered in symbol input box 408. A home selection tab 418 may operate to provide a mechanism for displaying a user's home page. A portfolio selection tab 420 may operate to provide a mechanism for displaying a user's portfolio page.

Referring back to FIG. 2B, at step 216, the server may receive information corresponding to a user input. For example, the received information may indicate that a user input a financial instrument symbol into symbol input box 408 (FIG. 4) and selected spread chain selection 414 (FIG. 4).

At step 217, the server validates the information received at step 216. For receipt of an invalid entry at step 218, server communicates an error message with a request to enter a correct financial instrument symbol. Thereafter, processing continues at step 216.

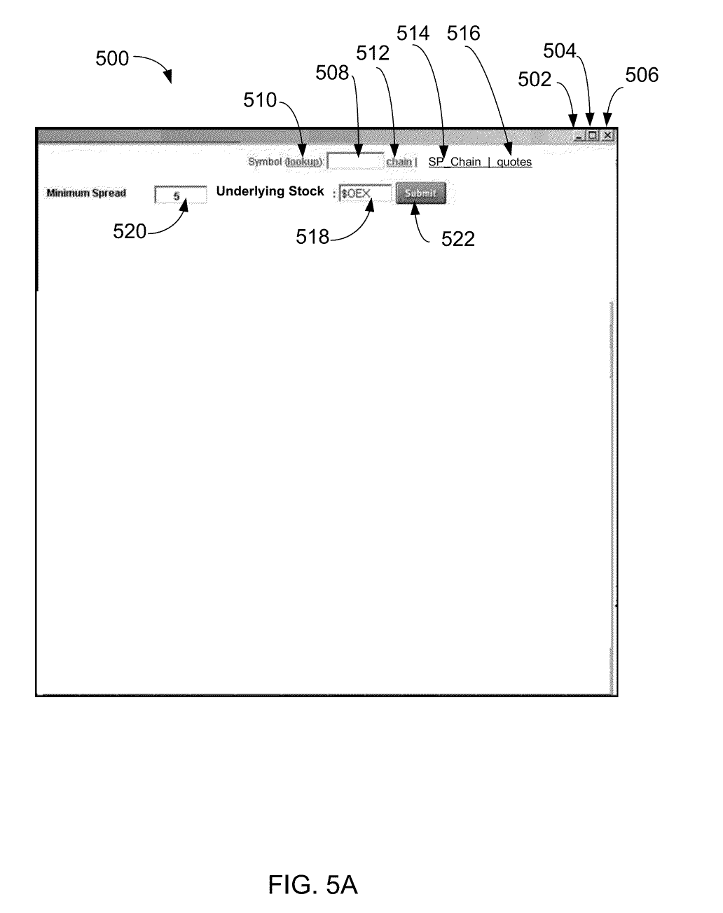

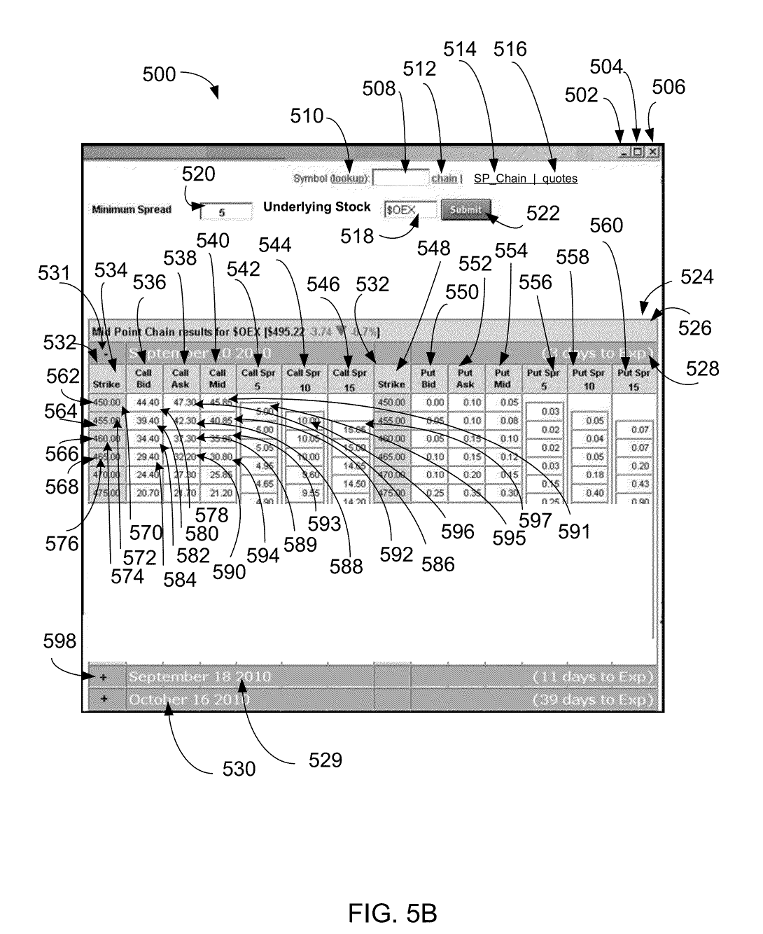

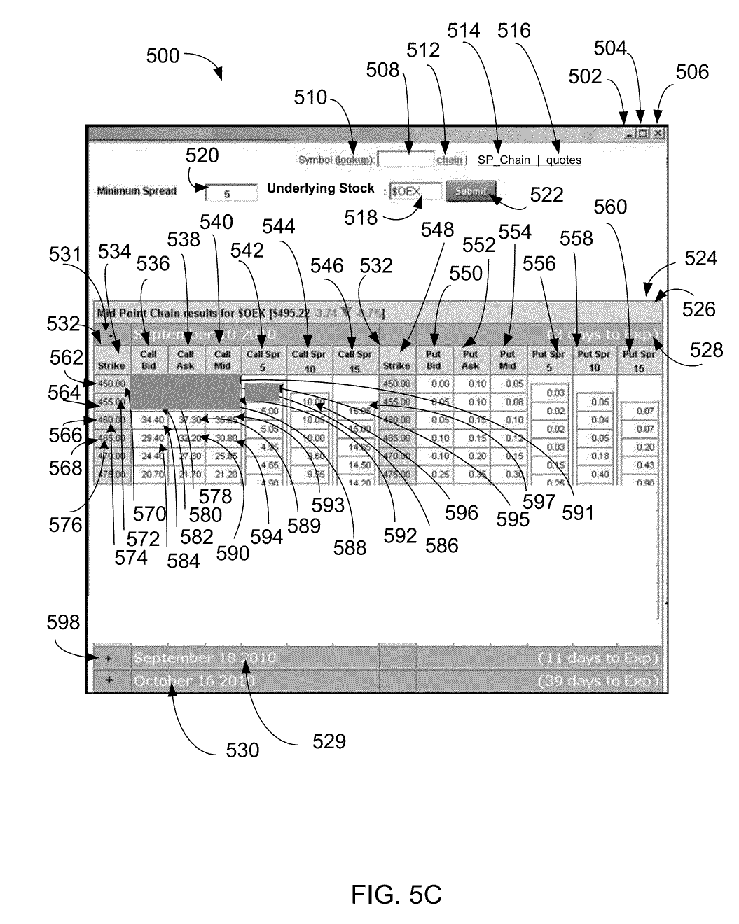

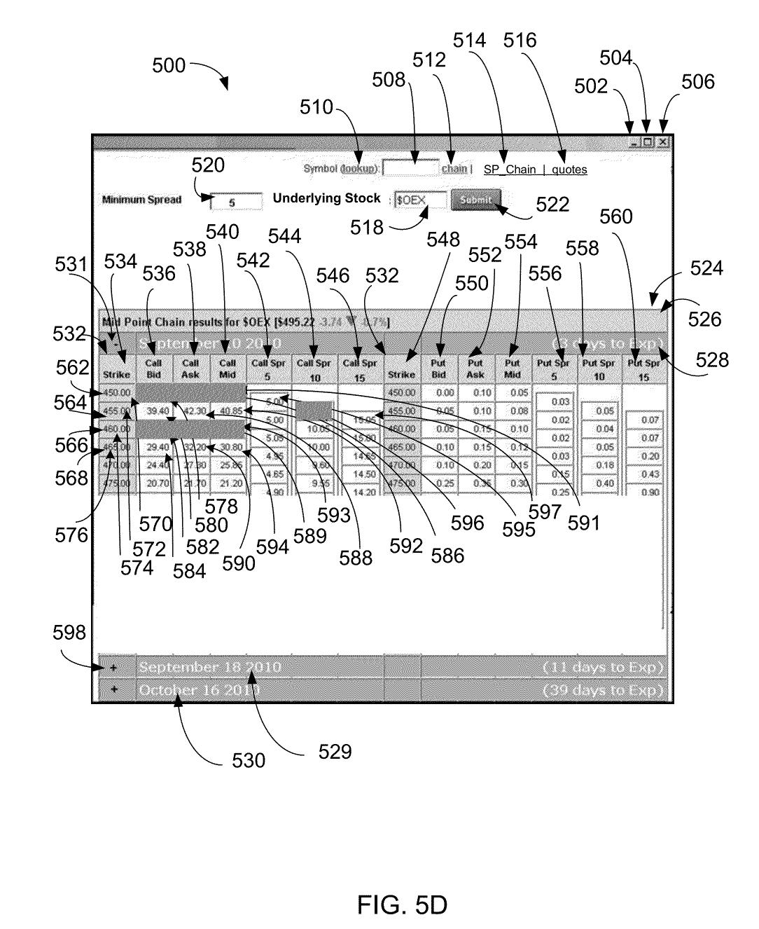

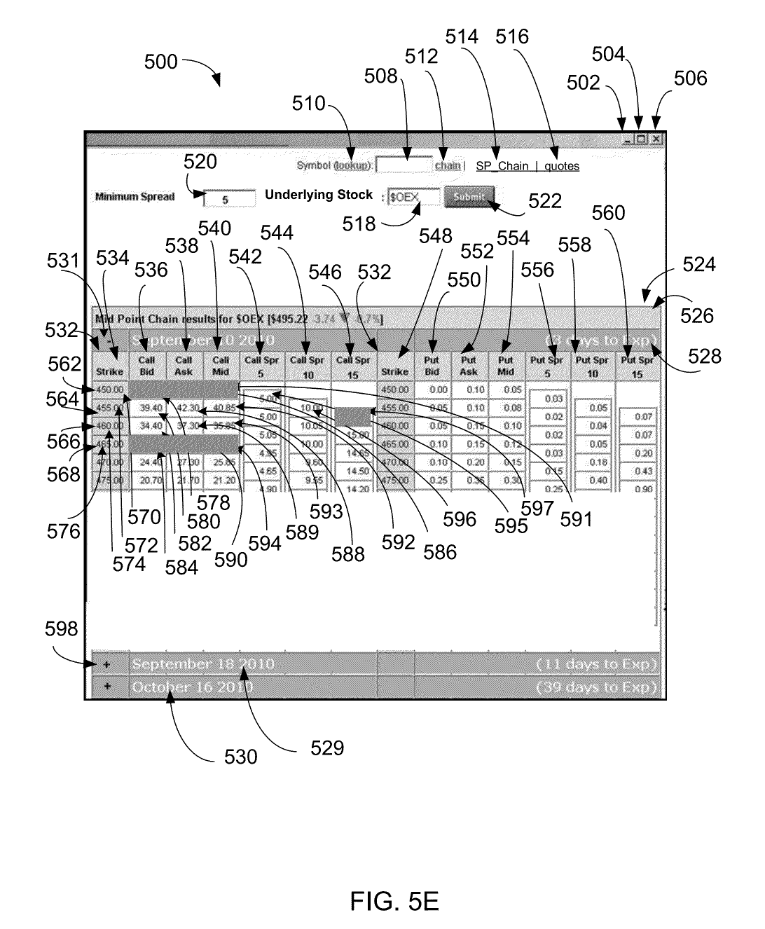

If at step 217, the server determines the received entry is valid, processing proceeds to step 219. At step 219, the server prepares and communicates information for displaying a user interface with which the user may enter additional information regarding the desired information. FIG. 5A depicts an example user interface screen that may be communicated to the user. An information display 500 provides a mechanism for spread chain information retrieval and display. Using a symbol input box 508, a user may enter a symbol for a financial instrument that they wish to receive information regarding. A symbol information selection or a link 510 provides a mechanism by which a user may request to retrieve information that may be useful in identifying a particular financial instrument that may be entered into symbol input box 508. A user may use an option chain selection 512 to request a mechanism for retrieval and display of an option chain for a financial instrument entered in symbol input box 508. A user may activate a spread chain selection 514 to request retrieval and display of a spread chain for a financial instrument entered in symbol input box 508. A quotes selection 516 operates to request retrieval of quote information related to a financial instrument entered in symbol input box 508. A user may use a symbol input box 518 to enter a financial instrument symbol for spread chain information retrieval and display. The user may use a minimum spread input box 520 to select the minimum spread for the requested spread chain. The user submits the request by depressing a submit button 522. The example display offers various navigation tools that are typically provided in graphical user interfaces. For example, information display 500 may further comprise a display minimize button 502 for minimizing information display 500, a display maximize button 504 for maximizing information display 500, and a display close button 506 for closing the display.

Referring back to FIG. 2C, at step 221, a user may enter a value for minimum spread in minimum spread input box 520 and a select submit button 522 to submit entry.

At step 222, the server receives symbol and minimum spread information and performs calculations associated with received symbol. Non-limiting examples of calculations performed include mid-range calculations, strike delta, maximum risk and potential return.

At step 223, the server communicates information corresponding to the user request. In an exemplary embodiment, the information comprises a spread chain for a financial instrument as depicted via information display 500 of FIG. 5B. Information display 500 includes elements of FIG. 5A with the addition of a spread chain display portion 524. Spread chain display portion 524 includes an information portion 526, an information portion 528, an information portion 529, and an information portion 530. Information portion 528 includes a display control 531 and a spread chain display portion 532.

Spread chain display portion 524 may operate to display information related to a spread chain. Information portion 526 may operate to display information related to the underlying financial instrument (e.g. price and price change). Information portion 528 may operate to display information related to the spread chains displayed below (e.g. month of expiration and days-to-expiration). Information portion 529 may operate to display information related to spread chains not displayed, but which may be displayed if selected. Information portion 530 may operate to display information related to spread chains not displayed, but which may be displayed if selected. Display control 531 may operate to display or not to display information related to information portion 528.

Spread chain display portion 532 includes a strike price column 534, a call option bid price column 536, a call option ask price column 538, a call option midpoint price column 540, a call option spread column 542, a call option spread column 544, a call option spread column 546, a strike price column 548, a put option bid price column 550, a put option ask price column 552, a put option midpoint price column 554, a put option spread column 556, a put option spread column 558, a put option spread column 560, an option strike row 562, an option strike row 564, an option strike row 566 and an option strike row 568.

Option strike row 562 may operate to display information related to financial instruments as represented by the strike price presented in a cell 570. Option strike row 564 may operate to display information related to financial instruments as represented by the strike price presented in a cell 572. Option strike row 566 may operate to display information related to financial instruments as represented by the strike price presented in a cell 574. Option strike row 568 may operate to display information related to financial instruments as represented by the strike price presented in a cell 576.

Spread chain display portion 532 may operate to display specific information related to spread chains for information portion 528. Strike price column 534 may operate to display information related to the strike price for listed call option financial instruments. In the example depicted in FIG. 5B, for strike price column 534, cell 570 indicates a strike price of “450.00”. Cell 572 indicates a strike price of “455.00”. Cell 574 indicates a strike price of “460.00”. Cell 576 indicates a strike price of “465.00”.

Call option bid price column 536 may operate to display information related to the bid price for listed call options. A call option bid price represents the price an investor may sell a call option financial instrument at the current market price. For call option bid price column 536, a cell 578 indicates a call option bid price of “44.40”. A cell 580 indicates a call option bid price of “39.40”. A cell 582 indicates a call option bid price of “34.40”. A cell 584 indicates a call option bid price of “29.40”.

Call option ask price column 538 may operate to display information related to the ask price for listed call options. A call option ask price represents the price an investor may purchase a call option financial instrument at the current market price. For call option ask price column 538, a cell 586 indicates a call option ask price of “47.30”. A cell 588 indicates a call option ask price of “42.30”. A cell 589 indicates a call option ask price of “37.30”. A cell 590 indicates a call option ask price of “32.20”.

Call option midpoint price column 540 may operate to represent the midpoint price as presented by call option bid price column 536 and call option ask price column 538. The calculation for call option midpoint price column 540 may be calculated as (call option bid price+(call option ask price−call option bid price)/2). For call option midpoint price column 540, a cell 591 indicates a call option midpoint price of “45.85”. A cell 592 indicates a call option midpoint price of “40.85”. A cell 593 indicates a call option midpoint price of “35.85”. A cell 594 indicates a call option midpoint price of “30.80”.

Call option spread column 542 may operate to represent the spread between midpoint prices of two financial instruments. Call option spread column 542 may be calculated as the difference between adjacent call option midpoint prices. Call option spread column 542 may be calculated as (financial instrument A midpoint price−financial instrument B midpoint price). For call option spread column 542, a cell 595 indicates a call option spread of “5.00”. For call option spread column 544, a cell 596 indicates a call option spread of “10.00”. For call option spread column 546, a cell 597 indicates a call option spread of “15.05”.

Call option spread column 544 may operate to represent the spread between midpoint prices of two financial instruments. Call option spread column 544 may be calculated as the difference between the midpoint prices of two financial instruments separated by one financial instrument. Call option spread column 544 may be calculated as (financial instrument A midpoint price−financial instrument C midpoint price).

Call option spread column 546 may operate to represent the spread between midpoint prices of two financial instruments. Call option spread column 546 may be calculated as the difference between the midpoint prices of two financial instruments separated by two financial instruments. Call option spread column 546 may be calculated as (financial instrument A midpoint price−financial instrument D midpoint price).

Strike price column 548 may operate to display information related to the strike price for listed put option financial instruments. Put option bid price column 550 may operate to display information related to the bid price for listed put options. A put option bid price represents the price an investor may sell a put option financial instrument at the current market price. Put option ask price column 552 may operate to display information related to the ask price for listed put options. A put option ask price represents the price an investor may purchase a put option financial instrument at the current market price. Put option midpoint price column 554 may operate to represent the midpoint price as presented by put option bid price column 550 and put option ask price column 552. The calculation for put option midpoint price column 554 may be calculated as (put option bid price+(put option ask price−put option bid price)/2). Put option spread column 556 may operate to represent the spread between midpoint prices of two financial instruments. Put option spread column 556 may be calculated as the difference between adjacent put option midpoint prices. Put option spread column 556 may be calculated as (financial instrument B midpoint price−financial instrument A midpoint price). Put option spread column 558 may operate to represent the spread between midpoint prices of two financial instruments. Put option spread column 558 may be calculated as the difference between the midpoint prices of two financial instruments separated by one financial instrument. Put option spread column 558 may be calculated as (financial instrument C midpoint price−financial instrument A midpoint price). Put option spread column 560 may operate to represent the spread between midpoint prices of two financial instruments. Put option spread column 560 may be calculated as the difference between the midpoint prices of two financial instruments separated by two financial instruments. Put option spread column 560 may be calculated as (financial instrument D midpoint price−financial instrument A midpoint price).

Option strike row 562 may operate to display information related to financial instruments as represented by the strike price presented in cell 570. Option strike row 564 may operate to display information related to financial instruments as represented by the strike price presented in cell 572. Option strike row 566 may operate to display information related to financial instruments as represented by the strike price presented in cell 574. Option strike row 568 may operate to display information related to financial instruments as represented by the strike price presented in cell 576.

Referring back to FIG. 2C, at step 224, the user may select a first spread. In response, at step 226, the server causes the selected spread to be emphasized for further evaluation as depicted in FIG. 5C.

Referring to FIG. 5C, information display 500 is depicted with a selected spread emphasized. In the depicted example, a user may have selected cell 595 via interface device 140. As a result of selecting cell 595, cells 595, 591, 592, 586, 588, 578 and 580 may be highlighted. Highlighting these cells may enable a user to determine the corresponding information related to the selected spread. For example, cell 595 indicates a call option spread of “5.00”. The call option spread value of “5.00” may be calculated as the difference between the call option midpoint prices indicated by cell 591, presented as “45.85”, and cell 592, presented as “40.85”. The call option midpoint price for cell 591, presented as “45.85”, may be calculated as the midpoint between the call option ask price of cell 586, presented as “47.30” and call option bid price of cell 578, presented as “44.40”. The call option midpoint price for cell 592, presented as “40.85”, may be calculated as the midpoint between the call option ask price of cell 588, presented as “42.30” and call option bid price of cell 580, presented as “39.40”. Furthermore, as a result of highlighting the cells, the strike prices for the options of the selected spread may be easily recognized as that of cell 570, presented as “450.00” and cell 572, presented as “455.00”. The combination of the spread calculations and cell highlighting enables a user to easily determine information related to a selected spread and to enable selection of a spread investment for trade execution.

Referring back to FIG. 2D, at step 227, the user may select a second spread for emphasis and evaluation. In response at step 228, the server may communicate instructions to highlight the spread corresponding to the user's selection. FIG. 5D depicts an exemplary user interface that the server may respond with. In an exemplary embodiment, a user may have selected cell 596 via interface device 140. As a result of selecting cell 596, cells 596, 591, 586, 578, 593, 589 and 582 may be highlighted. Highlighting these cells may enable a user to determine the corresponding information related to the selected spread. For example, cell 596 indicates a call option spread of “10.00”. The call option spread value of “10.00” may be calculated as the difference between the call option midpoint prices indicated by cell 591, presented as “45.85”, and cell 593, presented as “35.85”. The call option midpoint price for cell 591, presented as “45.85”, may be calculated as the midpoint between the call option ask price of cell 586, presented as “47.30” and call option bid price of cell 578, presented as “44.40”. The call option midpoint price for cell 593, presented as “35.85”, may be calculated as the midpoint between the call option ask price of cell 589, presented as “37.30” and call option bid price of cell 582, presented as “34.40”. Furthermore, as a result of highlighting the cells, the strike prices for the options of the selected spread may be easily recognized as that of cell 570, presented as “450.00” and cell 574, presented as “460.00”. The combination of the spread calculations and cell highlighting enables a user to easily determine information related to a selected spread and to enable selection of a spread for trade execution.

Referring back to FIG. 2D, at step 229, the user may select a third spread for emphasis and evaluation. In response at step 231, the sever may communicate instructions to highlight the spread corresponding to the user's selection. FIG. 5E depicts an example user interface that the system may respond with. In an example scenario, the user may select cell 597 via interface device 140. As a result of selecting cell 597, cells 597, 591, 586, 578, 584, 590 and 594 may be highlighted. Highlighting these cells may enable a user to determine the corresponding information related to the selected spread. For example, cell 597 indicates a call option spread of “15.05”. The call option spread value of “15.05” may be calculated as the difference between the call option midpoint prices indicated by cell 591, presented as “45.85”, and cell 594, presented as “30.80”. The call option midpoint price for cell 591, presented as “45.85”, may be calculated as the midpoint between the call option ask price of cell 586, presented as “47.30” and call option bid price of cell 578, presented as “44.40”. The call option midpoint price for cell 594, presented as “30.80”, may be calculated as the midpoint between the call option ask price of cell 590, presented as “32.20” and call option bid price of cell 584, presented as “29.40”. Furthermore, as a result of highlighting the cells, the strike prices for the options of the selected spread may be easily recognized as that of cell 570, presented as “450.00” and cell 576, presented as “465.00”. The combination of the spread calculations and cell highlighting enables a user to easily determine information related to a selected spread and to enable selection of a spread for trade execution.

In connection with FIGS. 5A-E, the operation for information display 500 has been described with reference to call option financial instruments. Those skilled in the art will appreciate that similar processing may be performed for put option financial instruments.

Referring back to FIG. 2D, at step 232, user may select a position to trade. At step 233, the server (e.g. server device 108 (FIG. 1)) may receive information associated with selected position for trading. At step 234, server (e.g. server device 108 (FIG. 1)) performs calculations associated with the position for trading. Non-limiting examples of calculations performed include identifying a start price at which to attempt to execute the trade, identifying an end price at which to attempt to execute the trade, and decrement price identifying the amount that the price should be decremented in attempting to execute the trade.

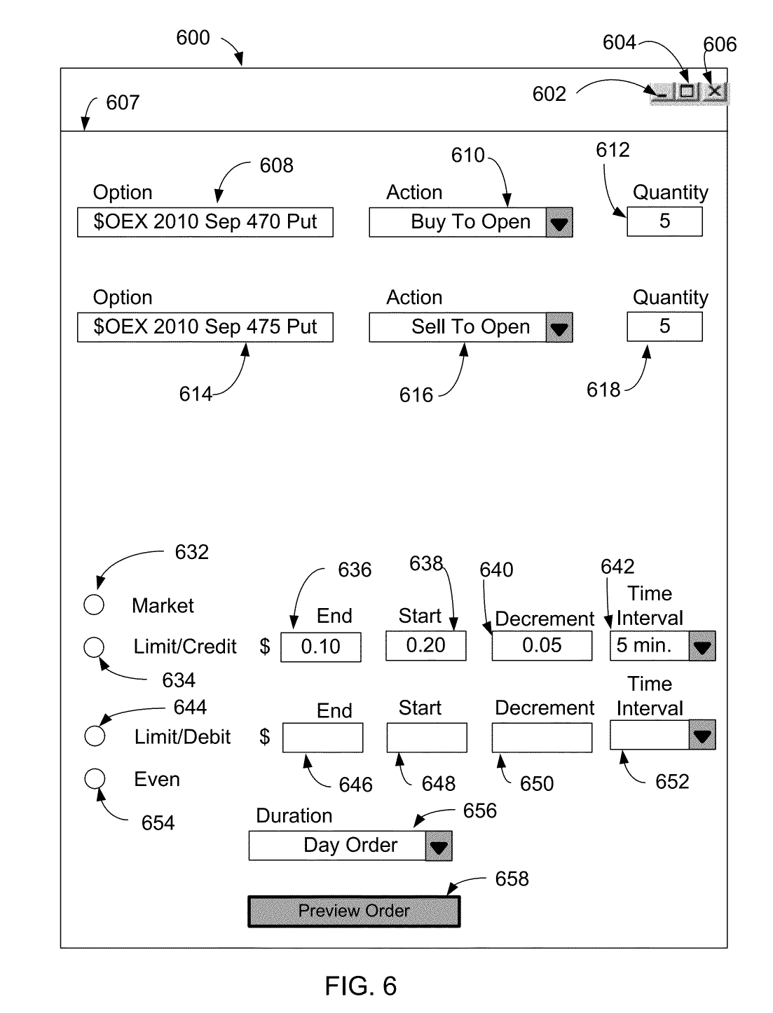

At step 236, the server generates a user interface and communicates it to the user in connection with the requested trade. FIG. 6 illustrates an illustrative user interface that allows a user to view, modify and configure information related to a potential trade execution including the capability to configure a trade execution for automatic limit price modification. As shown in FIG. 6, an information display 600 may operate to present information and receive input for performing trading of financial instruments. A trade entry portion 607 includes a first financial instrument information portion 608, a first financial instrument action portion 610, a first financial instrument quantity portion 612, a second financial instrument information portion 614, a second financial instrument action portion 616, a second financial instrument quantity portion 618, a market selection 632, a limit-credit selection 634, an end price portion 636, a start price portion 638, a price decrement portion 640, a time interval portion 642, a limit-debit selection 644, an end price portion 646, a start price portion 648, a price increment portion 650, a time interval portion 652, an even selection 654, a trade duration portion 656 and a preview order button 658.

Trade entry portion 607 may operate to present information and receive input for performing trading of financial instruments. First financial instrument information portion 608 may operate to present and receive information related to a first financial instrument for inclusion in a trade. Non-limiting examples of information first financial instrument information portion 608 may present and receive include underlying financial instrument, year of expiration, month of expiration, strike price and financial instrument type. First financial instrument action portion 610 may operate to present and receive information for the types of operations which may be performed for first financial instrument. Non-limiting examples for the types of operations which may be performed for a financial instrument include Sell-to-Close (STC), Buy-to-Close (BTC), Buy-to-Open (BTO) or Buy-to-Close (BTC). First financial instrument quantity portion 612 may operate to present and receive information related to the quantity of first financial instrument to be traded.

Second financial instrument information portion 614 may operate to present and receive information related to a second financial instrument for inclusion in the trade. Non-limiting examples of information second financial instrument information portion 614 may present and receive include underlying financial instrument, year of expiration, month of expiration, strike price and financial instrument type. Second financial instrument action portion 616 may operate to present and receive information for the types of operations which may be performed for second financial instrument. Non-limiting examples for the types of operations which may be performed for a financial instrument include STC, BTC, BTO or BTC. Second financial instrument quantity portion 618 may operate to present and receive information related to the quantity of second financial instrument to be traded.

Market selection 632, limit-credit selection 634, limit-debit selection 644 and even selection 654 may operate for a user to select price information related to trading first financial instrument and second financial instrument. One of market selection, limit-credit selection 634, limit-debit selection 644 and even selection 654 may be selected during any given period of time. Market selection 632 may operate to indicate performance of a trade at market prices. Limit-credit selection 634 may operate to indicate performance of a trade with a minimum net credit. Limit-debit selection 644 may operate to indicate performance of a trade with a maximum net debit. Even selection 654 may operate to indicate a trade may be performed for with no additional net credit or net debit.

End price portion 636 may operate to present and receive information related to an ending or last price for limit-credit selection 634. Start price portion 638 may operate to present and receive information related to a starting or beginning price for limit-credit selection 634. Price decrement portion 640 may operate to present and receive information related to decrementing a price associated with limit-credit selection 634. Time interval portion 642 may operate to present and receive information related to a time interval for decrementing a price associated with limit-credit selection 634 and with price decrement portion 640.

End price portion 646 may operate to present and receive information related to an ending or last price for limit-debit selection 644. Start price portion 648 may operate to present and receive information related to a starting or beginning price for limit-debit selection 644. Price increment portion 650 may operate to present and receive information related to incrementing a price associated with limit-debit selection 644. Time interval portion 652 may operate to present and receive information related to a time interval for decrementing a price associated with limit-debit selection 644 and with price increment portion 650.

Trade duration portion 656 may operate to present and receive information related to the duration of a trade. Non-limiting examples for duration of trade include day order and good until canceled. Preview order button 658 may operate to enable preview of a financial instrument order prior to submission for execution.

Referring to FIG. 2E, at step 238, the server receives the information specifying the parameters of the trade and forward the information for execution by a broker. At step 239 (FIG. 2F), selected trade may be executed by broker.

At step 241, server (e.g. server device 108 (FIG. 1)) may receive and store information associated with the execution of the trade. For example, the server may receive information regarding successful execution of the trade and the price details regarding the trade. At step 242, the server (e.g. server device 108 (FIG. 1)) may communicate information regarding the trade to the user. At step 243, server (e.g. server device 108 (FIG. 1)) may store information associated with trade execution. Non-limiting examples of entities for storing trade execution information include memory, hard disk, database and database associated with portfolio information.

In the discussion above, the disclosed system is employed to identify new options trade opportunities. The disclosed system may also be employed to find potential trade opportunities given an existing position. At step 244, a determination is made as to whether the user wishes to perform an analysis of an existing position or portfolio. If not, at step 246, processing pauses.

At step 247, the user may navigate to display existing portfolio positions. For example, a user may select portfolio selection tab 420 as depicted in FIG. 4. At step 248, server (e.g. server device 108 (FIG. 1)) may operate to retrieve stored information associated with trade execution.

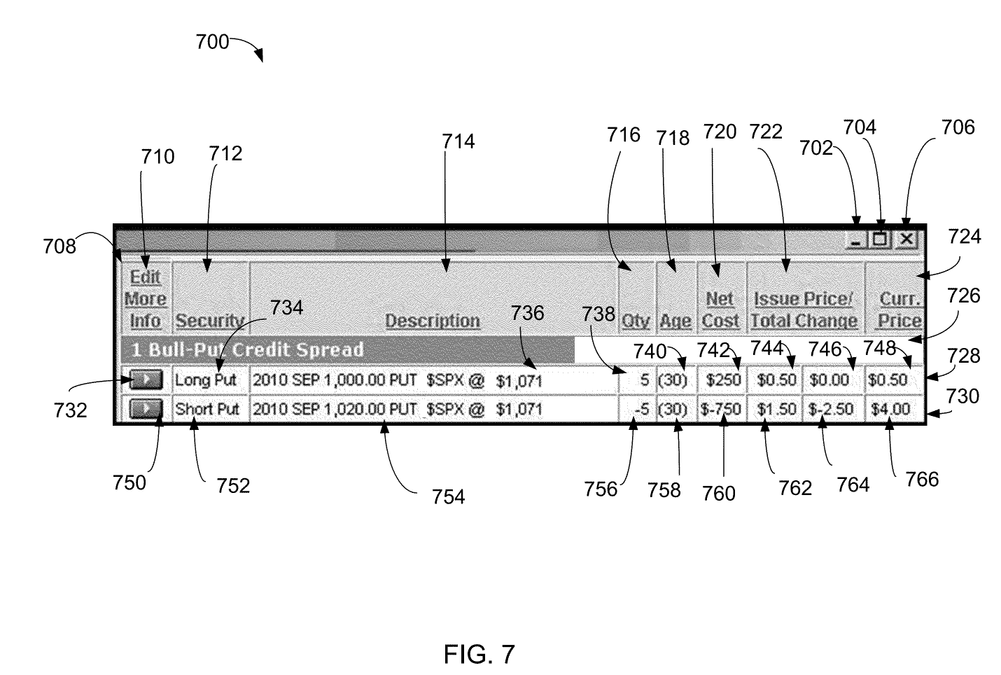

At step 249, server (e.g. server device 108 (FIG. 1)) may operate to present retrieved information associated with prior trade executions to a user. In an example embodiment, the server may communicate a display such as depicted in FIG. 7. In the scenario depicted in FIG. 7, the existing position is a bull-put credit spread.

For existing positions, a position display portion 708 includes an information-edit column 710, a financial instrument column 712, a financial instrument description column 714, a financial instrument quantity column 716, a day quantity column 718, a net cost column 720, an issue price column 722, a total price change column 723, a current price column 724, a position information portion 726, a portfolio first financial instrument information row 728 and a portfolio second financial instrument information row 730.

Position display portion 708 may operate to present current positions a user may be tracking. Information-edit column 710 may operate to enable a user to select, retrieve, display and edit information related to a financial instrument. Financial instrument column 712 may operate to display type information for a financial instrument. Financial instrument description column 714 may operate to display information related to a financial instrument. Financial instrument quantity column 716 may operate to display the quantities of financial instruments, which may have been bought or sold to open. Day quantity column 718 may operate to display the number of days until a financial instrument expires. Net cost column 720 may operate to display the net cost for buying or selling to open a financial instrument. Issue price column 722 may operate to display the price for a financial instrument when bought or sold to open. Total price change column 723 may operate to display the price change of a financial instrument from when purchased or sold to open. Current price column 724 may operate to display the current market price for buying or selling to close a financial instrument. Position information portion 726 may operate to display information related to a financial instrument (e.g. strategy). Portfolio first financial instrument information row 728 may operate to present information related to a portfolio first financial instrument. Portfolio second financial instrument information row 730 may operate to display information related to a portfolio second financial instrument.

For portfolio first financial instrument information row 728, a selection button 732 may be selected for a portfolio first financial instrument. A cell 734 indicates a financial instrument type of “Long Put” for portfolio first financial instrument. A cell 736 indicates a financial instrument description of “2010 SEP 1,000.00 PUT $SPX @ $1,071”. A cell 738 indicates a financial instrument quantity of “5” for portfolio first financial instrument. A cell 740 indicates a day quantity of “30” for portfolio first financial instrument. A cell 742 indicates a net cost of “$250” for portfolio first financial instrument. A cell 744 indicates an issue price of “$0.50” for portfolio first financial instrument. A cell 746 indicates a total price change of “$0.00” for portfolio first financial instrument. A cell 748 indicates a current price of “$0.50” for portfolio first financial instrument.

For portfolio second financial instrument information row 730, a selection button 750 may be selected for portfolio second financial instrument. A cell 752 indicates a financial instrument type of “Short Put” for portfolio second financial instrument. A cell 754 indicates a financial instrument description of “2010 SEP 1,020.00 PUT $SPX @ $1,071”. A cell 756 indicates a financial instrument quantity of “−5” for portfolio second financial instrument. A cell 758 indicates a day quantity of “30” for portfolio second financial instrument. A cell 760 indicates a net cost of “$−750” for portfolio second financial instrument. A cell 762 indicates an issue price of “$1.50” for portfolio second financial instrument. A cell 764 indicates a total price change of “$−2.50” for portfolio second financial instrument. A cell 766 indicates a current price of “$4.00” for portfolio second financial instrument.

Users may minimize an information display 700 by selecting display a minimize button 702. Users may maximize information display 700 by selecting display a maximize button 704. Users may close information display 700 by selecting a display close button 706.

Referring back to FIG. 2G, at step 251, a user may select an existing position for analysis. For example to analyze a position, as depicted in information display 700 (FIG. 7), including first financial instrument as depicted by portfolio first financial instrument information row 728 and second financial instrument as depicted by portfolio second financial instrument information row 730, user may select selection button 732 followed by selecting to analyze the position.

At step 252, the server makes a determination as to whether the user has requested to manage or perform scenario analysis for an existing position. If the user has requested to manage a position or positions, at step 253, server (e.g. server device 108 (FIG. 1)) may retrieve information associated with managing a position or positions.

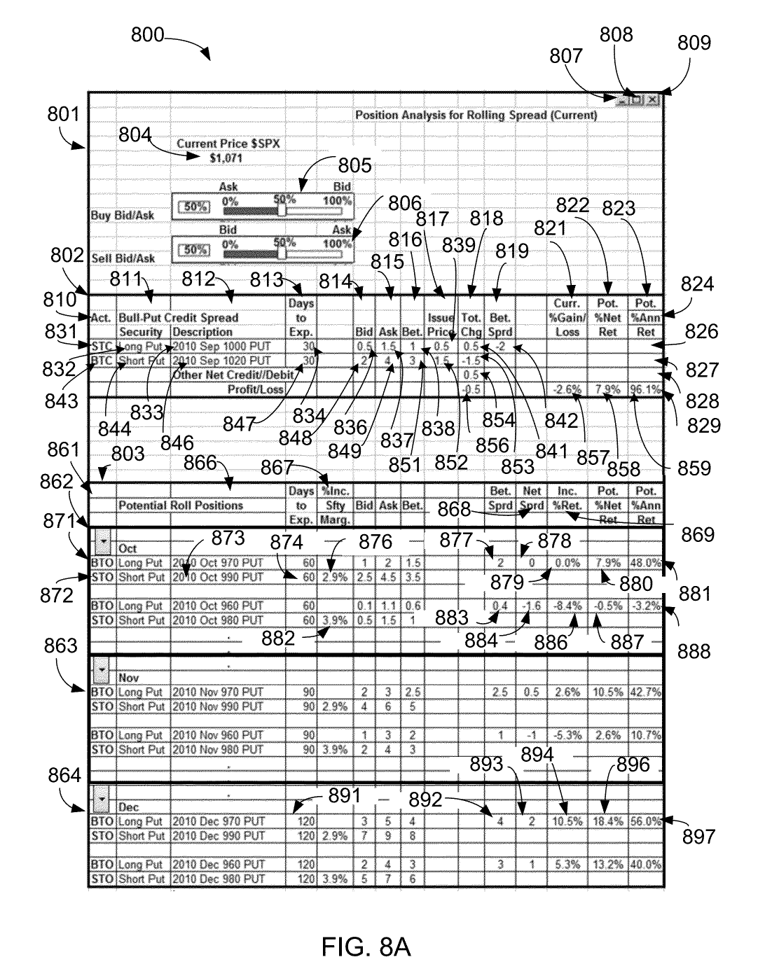

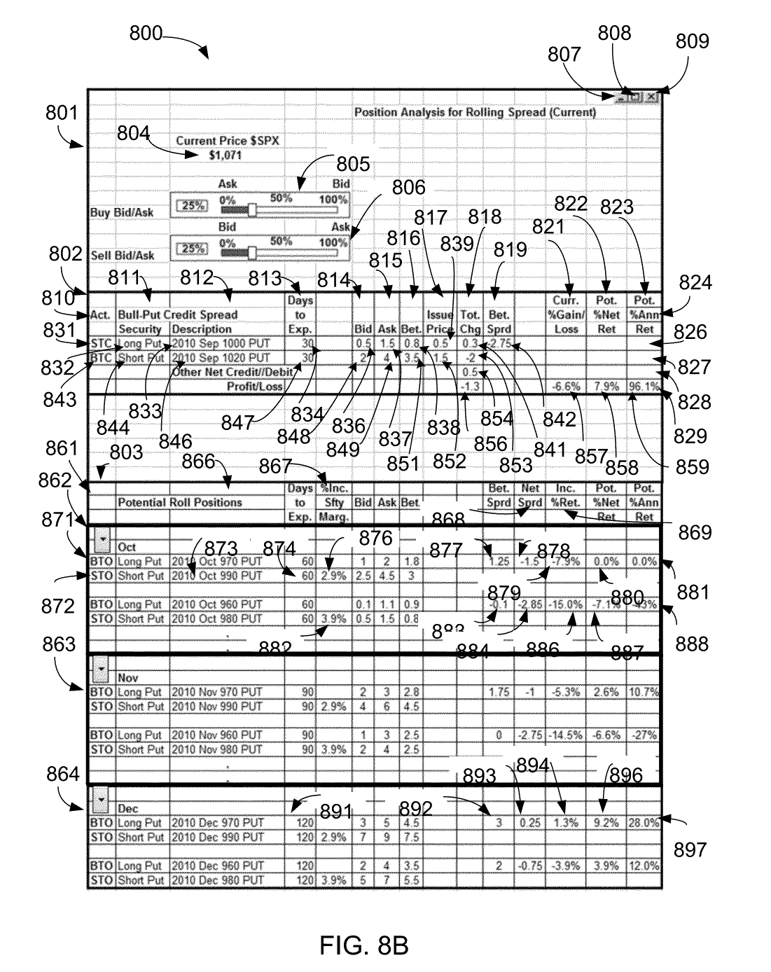

At step 254, the server may operate to perform calculations and may present the user with position analysis information as depicted via an information display 800 as illustrated in FIG. 8A. FIG. 8A illustrates a mechanism for a user to view, configure and analyze a current position in conjunction with potential positions to determine appropriate potential positions for replacing the current position. A user may also select a potential position for trade execution for replacing a current position.

As shown, information display 800 includes an information and control portion 801, a current position portion 802 and a potential positions portion 803.

Information and control portion 801 may operate to enable a user to view information related to an existing investment position and control the display of information. Information and control portion 801 includes a current price display 804, a buy bid-ask control 805, a sell bid-ask control 806, a display minimize button 807, a display maximize button 808, and a display close button 809. Buy bid-ask control 805 may operate to control calculation and display of information related to an option with the intent of purchasing. Sell bid-ask control 806 may operate to control calculation and display of information related to an option with the intent of selling.

Current position portion 802 includes a trade activity column 810, a financial instrument type column 811, a financial instrument description column 812, a days-to-expiration column 813, a bid price column 814, an ask price column 815, a price between column 816, an issue price column 817, a total price change column 818, a between spread price column 819, a current percent gain-loss column 821, a potential percent net return column 822, a potential percent annual return column 823, a header row 824, a first financial instrument row 826, a second financial instrument row 827, an other net credit-debit row 828 and a profit-loss row 829.

A cell 831 indicates a trade activity of “STC” for first financial instrument. A cell 832 indicates a financial instrument type of “Long Put” for first financial instrument. A cell 833 indicates a financial instrument description of “2010 September 1000 PUT” for first financial instrument. A cell 834 indicates a days-to-expiration of “30” for first financial instrument. A cell 836 indicates a bid price of “0.5” for first financial instrument. A cell 837 indicates an ask price of “1.5” for first financial instrument. A cell 838 indicates a between price of “1” for first financial instrument. A cell 839 indicates an issue price of “0.5” for first financial instrument. A cell 841 indicates a total price change of “0.5” for first financial instrument. A cell 842 indicates a between spread price of “−2” for first financial instrument and second financial instrument.

A cell 843 indicates a trade activity of “BTC” for second financial instrument. A cell 844 indicates a financial instrument type of “Short Put” for second financial instrument. A cell 846 indicates a financial instrument description of “2010 September 1020 PUT” for second financial instrument. A cell 847 indicates a days-to-expiration of “30” for second financial instrument. A cell 848 indicates a bid price of “2” for second financial instrument. A cell 849 indicates an ask price of “4” for second financial instrument. A cell 851 indicates a between price of “3” for second financial instrument. A cell 852 indicates an issue price of “1.5” for second financial instrument. A cell 853 indicates a total price change of “−1.5” for second financial instrument.

A cell 854 indicates another net credit-debit of “0.5”. A cell 856 indicates a profit-loss of “−0.5” for current position. A cell 857 indicates a current percent gain-loss of “−2.6%” for current position. A cell 858 indicates a potential percent net return of “7.9%” for current position. A cell 859 indicates a potential percent annual return of “96.1%” for current position.

Potential positions portion 803 includes a header row portion 861, a multiplicity of potential month portions with a sampling denoted as a first potential month portion 862, a second potential month portion 863 and a third potential month portion 864. Header row portion 861 includes columns as depicted for header row 824 plus a potential roll positions column 866, a safety margin percent increase column 867, a net spread price column 868 and an incremental percent return column 869. First potential month portion 862 includes a third financial instrument row 871 and a fourth financial instrument row 872. A cell 873 indicates a financial instrument description of “2010 Oct 990 PUT” for fourth financial instrument. A cell 874 indicates a days-to-expiration of “60” for fourth financial instrument. A cell 876 indicates a safety margin percent increase of “2.9%” for third and fourth financial instruments. A cell 877 indicates a between spread price of “2” for third and fourth financial instruments. A cell 878 indicates a net spread price of “0” for third and fourth financial instruments. A cell 879 indicates an incremental percent return of “0.0%” for third and fourth financial instruments. A cell 880 indicates a potential percent net return of “7.9%” for third and fourth financial instruments. A cell 881 indicates a potential percent annual return of “48.0%” for third and fourth financial instruments.

A cell 882 indicates a safety margin percent increase of “3.9%” for fifth and sixth financial instruments. A cell 883 indicates a between spread price of “0.4” for fifth and sixth financial instruments. A cell 884 indicates a net spread price of “−1.6” for fifth and sixth financial instruments. A cell 886 indicates an incremental percent return of “−8.4%” for fifth and sixth financial instruments. A cell 887 indicates a potential percent net return of “−0.5%” for fifth and sixth financial instruments. A cell 888 indicates a potential percent annual return of “−3.2%” for fifth and sixth financial instruments.

Second potential month portion 863 may operate to present information related to potential positions for rolling position associated with current position portion 802.

Third potential month portion 864 may operate to present information related to potential positions for rolling position associated with current position portion 802. A cell 891 indicates a days-to-expiration of “120” for seventh financial instrument. A cell 892 indicates a between spread price of “4” for seventh and eighth financial instruments. A cell 893 indicates a net spread price of “2” for seventh and eighth financial instruments. A cell 894 indicates an incremental percent return of “10.5%” for seventh and eighth financial instruments. A cell 896 indicates a potential percent net return of “18.4%” for seventh and eighth financial instruments. A cell 897 indicates a potential percent annual return of “56.0%” for seventh and eighth financial instruments.

Current price display 804 may operate to present a financial instrument related to an existing position and present a current price for the financial instrument. Buy bid-ask control 805 may operate to control the calculation of price between the bid and ask prices for a financial instrument for sale. Sell bid-ask control 806 may operate the calculation of a price between the bid and ask prices for a financial instrument for purchase.

Current position portion 802 may operate to display information related to an existing investment. Trade activity column 810 may operate to present an operation to be performed for a financial instrument. Non-limiting examples for the types of operations which may be performed for a financial instrument include STC, BTC, BTO or BTC. Financial instrument type column 811 may operate to present the type for a financial instrument. Non-limiting examples for the type of financial instrument include Long Put Option, Short Put Option, Long Call Option, Short Call Option, Stock, Exchange Traded Fund (ETF), Mutual Fund and Bond. Financial instrument description column 812 may operate to present a description for a financial instrument. Non-limiting examples of information for the description of a financial instrument include year of expiration, month of expiration, strike price and type of option. Days-to-expiration column 813 may operate to present the number of days until a listed financial instrument expires. Bid price column 814 may operate to present the bid price for a listed financial instrument. Bid price may operate to represent the market price for which a financial instrument may be sold. Ask price column 815 may to present the ask price for a listed financial instrument. Ask price may operate to represent the market price for which a financial instrument may be purchased. Price between column 816 may operate to present a price calculated between the bid price and ask price for a financial instrument. The calculation for price between column 816 for a financial instrument for sale may be represented as (bid price+(ask price−bid price)*(value of sell bid-ask control 806)). The calculation for price between column 816 for a financial instrument for purchase may be represented as (bid price+(ask price−bid price)*(value of buy bid-ask control 805)). Issue price column 817 may operate to present the sale or purchase price for an existing investment position. Total price change column 818 may operate to present the price change as related to the issue price for an existing position and with respect to the between price for the financial instrument. For a purchased or long financial instrument, total price change column 818 may be calculated as (price between−issue price). For a sold or short financial instrument, total price change column 818 may be calculated as (issue price−between price). Between spread price column 819 may operate to present the difference between a price between for a purchased or long financial instrument and a sold or short financial instrument. Between spread price column 819 may be calculated as (price between long position−price between short position). Current percent gain-loss column 821 may operate to present a percentage gain or loss for an existing position with respect to exiting the position and receiving pricing with respect to the price between bid and ask for the respective financial instruments. Potential percent net return column 822 may operate to present the potential return for an investment position with conditions for a favorable outcome. Potential percent annual return column 823 represents the annualized return for an investment position with conditions for a favorable outcome.

Header row 824 may operate to describe elements depicted below header row 824. First financial instrument row 826 may operate to depict information related to a first financial instrument. Non-limiting examples of information first financial instrument row 826 may depict include trade activity, type of financial instrument, description of financial instrument, days-to-expiration, bid price, ask price, between price, issue price, total price change and between spread price. Second financial instrument row 827 may operate to depict information related to a second financial instrument. Non-limiting examples of information second financial instrument row 827 may depict include trade activity, type of financial instrument, description of financial instrument, days-to-expiration, bid price, ask price, between price, issue price, total price change and between spread price. Other net credit-debit row 828 may operate to depict information related to other related net credits or net debits. Non-limiting examples of other net credits or net debits include closing a portion of a position, opening a new position and rolling a position. Profit-loss row 829 may operate to present a total profit and loss with respect to first financial instrument, second financial instrument and/or other related net credits or net debits. Non-limiting examples of information depicted by profit-loss row 829 include total price change profit/loss, current percentage profit/loss, potential percentage profit/loss and potential percentage annualized profit/loss.

Cell 831 may operate to depict trade activity associated with first financial instrument. Non-limiting examples of trade activity include STC, BTC, BTO and STO. Cell 832 may operate to depict the type of financial instrument for first financial instrument. Non-limiting examples of financial instrument types include long put, short put, long call, short call, long stock and short stock. Cell 833 may operate to present description information related to first financial instrument. Non-limiting examples of information presented by cell 833 include year, month, strike, financial instrument and type of financial instrument. Cell 834 may operate to depict the number of days until expiration for first financial instrument. Cell 836 may operate to depict the bid price for first financial instrument, where bid price may refer to a market price for which first financial instrument may be sold. Cell 837 may operate to depict the ask price for a first financial instrument, where ask price may refer to a market price for which first financial instrument may be purchased. Cell 838 may operate to depict a calculation for a between price. The calculation for cell 838 may be represented as (bid price+(ask price−bid price)/2) or (value of cell 836+(value of cell 837−value of cell 836)/2). Cell 839 may operate to present an issue price for first financial instrument. Cell 841 may operate to present a total price change for first financial instrument with respect to the between price. The calculation for cell 841 for a long position may be represented as (between price−issue price) or (value of cell 838−value of cell 839).

Cell 843 may operate to depict trade activity associated with second financial instrument. Non-limiting examples of trade activity include STC, BTC, BTO and STO. Cell 844 may operate to depict the type of financial instrument for first financial instrument. Non-limiting examples of financial instrument types include long put, short put, long call, short call, long stock and short stock. Cell 846 may operate to present description information related to first financial instrument. Non-limiting examples of information presented by cell 846 include year, month, strike, financial instrument and type of financial instrument. Cell 847 may operate to depict the number of days until expiration for second financial instrument. Cell 848 may operate to depict the bid price for second financial instrument, where bid price may refer to a market price for which second financial instrument may be sold. Cell 849 may operate to depict the ask price for a second financial instrument, where ask price may refer to a market price for which second financial instrument may be purchased. Cell 851 may operate to depict a calculation for a between price. The calculation for cell 851 may be represented as (bid price+(ask price−bid price)/2) or (value of cell 848+(value of cell 849−value of cell 848)/2). Cell 852 may operate to present an issue price for second financial instrument. Cell 853 may operate to present a total price change for second financial instrument with respect to the between price. The calculation for cell 853 for a short position may be represented as (issue price−between price) or (value of cell 852−value of cell 851).

Cell 842 may operate to present a between spread for the total change between the price for first financial instrument and second financial instrument. The calculation for cell 842 may be represented as (total price change for first financial instrument−total price change for second financial instrument) or (value of cell 841−value of cell 853). Cell 854 may operate to present a net credits or debits from previous positions or position management. Non-limiting examples of previous positions or position management include rolling a position or expiration of a position and closing a portion of a position. Cell 856 indicates a current profit loss for a position with respect to a between price and with respect to previous positions and position management. The calculation for cell 856 may be represented as the sum of the total price change for first financial instrument, the total price change for second financial instrument and other net credits/debits. The calculation for cell 856 may also be represented as: (value of cell 841+value of cell 853+value of cell 854).

Cell 857 may operate to present a current percent gain-loss for the aggregate of first and second financial instruments and other net credits/debits. The calculation for cell 857 may be represented as (current profit/loss/capital invested)*100%. Current profit/loss may be represented by cell 856 or −0.5. The capital invested per financial instrument for this example may be calculated as the initial net credit for the position (value of cell 852−value of cell 839, or 1.0 for this example) subtracted from the difference between the strike prices for first financial instrument and second financial instrument, ((1020−1000)−1.0) or 19. The calculation for cell 857 may be represented as (−0.5)/(19)*100% or 2.6%.

Cell 858 may operate to present a potential percent return for an investment position. The calculation for cell 858 may be represented as (potential profit/loss/capital invested)*100%. For this example, the calculation for potential profit/loss may be represented as ((second financial instrument issue price−first financial instrument issue price)+other net credits/debits). The calculation for potential profit/loss may also be represented as ((value of cell 852−value of cell 839)+value of cell 854) or ((1.5−0.5)+0.5) which may be represented as 1.5. Capital invested discussed previously in the prior paragraph may be represented as 19. The calculation for cell 858 may be represented as (1.5)/(19) or 7.9%.

Cell 859 may operate to present a potential percent annual return for an investment position. The calculation for cell 859 may be represented as (potential percent return per day*365). Potential percent return per day may be calculated as (potential percent return/expected number of days in position). For this example, the expected number of days in position may be represented as 30 days and the potential return per day may be calculated as (7.9%/30) or 0.2633%. The calculation for cell 859 may be represented as (0.2633%*365) or 96.1%.

Potential roll positions column 866 may operate to represent information related to potential positions for rolling or managing first and second financial instruments. Non-limiting examples of information presented by potential roll positions column 866 include investment strategy, trade activity and financial instrument description. Safety margin percent increase column 867 may operate to represent an increase or decrease in safety margin as related to a new potential investment. Net spread price column 868 may operate to represent the net spread for rolling or managing a position. A positive value for a value in net spread price column 868 may indicate additional potential return may be realized after position management, a negative value for a value in net spread price column 868 may indicate less potential return may be realized after position management and a zero value for a value in net spread price column 868 may indicate the potential return after position management remains unchanged from the prior position. Incremental percent return column 869 may operate to represent an incremental percent return for a position after position management. A positive value for a value in incremental percent return column 869 may indicate additional potential return may be realized after position management, a negative value in incremental percent return column 869 may indicate decreased potential return may be realized after position management and a zero value in incremental percent return column 869 may indicate the potential return after position management remains unchanged from the prior position.

Third financial instrument row 871 may operate to depict information related to a third financial instrument. Non-limiting examples of information third financial instrument row 871 may depict include trade activity, type of financial instrument, description of financial instrument, days-to-expiration, safety margin, bid price, ask price, between price, between spread price, net spread price, incremental percent return, potential percent net return and potential percent annual return.

Fourth financial instrument row 872 may operate to depict information related to a third financial instrument. Non-limiting examples of information fourth financial instrument row 872 may depict include trade activity, type of financial instrument, description of financial instrument, days-to-expiration, safety margin, bid price, ask price, between price, between spread price, net spread price, incremental percent return, potential percent net return and potential percent annual return.

Cell 873 may operate to present financial instrument description for fourth financial instrument. For this example, the strike price for fourth financial instrument may be represented as “990”. Cell 874 may operate to present the number of days until expiration for fourth financial instrument. Cell 876 may operate to present a change in safety margin for rolling position as denoted by first and second financial instruments to third and fourth financial instruments. For this example, the calculation for the change in safety margin as depicted by cell 876 may be represented as ((second financial instrument strike price−fourth financial instrument strike price)/second financial instrument strike price) or ((1020−990)/1020) which may be determined as 2.9%. Cell 877 may operate to represent a between spread for third and fourth financial instrument and may be defined and calculated similarly as previously discussed with respect to cell 842 for first and second financial instrument. Cell 878 may operate to represent a net spread with respect to the between spread for first and second financial instruments and the between spread for third and fourth financial instruments. The calculation for cell 878 may be represented as (third/fourth financial instruments between spread+first/second financial instruments between spread) or (the value of cell 877+the value of cell 842). The calculation for cell 878 may be represented as (2+(−2)) with the resulting value determined as 0. Cell 879 may operate to represent an incremental percent return with respect to rolling or managing a position. The calculation for cell 879 may be represented as (net spread/capital invested)*100%. Capital invested may be defined and calculated as discussed previously with respect to first and second financial instruments. The calculation for cell 879 may also be represented as (value of cell 878/capital invested)*100%) or (0/19)*100% with the resulting value determined as 0.0%. Cell 880 may operate to represent a potential percent net return with respect to rolling or managing a position. The calculation for cell 880 may be represented as (previous potential percent net return+incremental percent return). The calculation for cell 880 may also be represented as (value of cell 858+value of cell 879) or (7.9%+0.0%) with the resulting value determined as 7.9%. Cell 881 may operate to represent a potential percent annual return with respect to rolling or managing a position. The calculation for cell 881 may be defined and calculated similarly as discussed with respect to cell 859. For cell 881, the expected number of days in position may be represented as 60 days or 30 days longer than as previously discussed with respect to first and second financial instruments. The 60 days may be considered a result of rolling a position to financial instruments with a longer period of days-to-expiration. For this example, the return per day may be calculated as (7.9%/60) or 0.1317%. The calculation for cell 881 may be represented as (0.1317%*365) or 48.0%.

Cell 882 may operate to represent a change in safety margin for fifth and sixth financial instruments. The larger safety margin as depicted by cell 882 for fifth and sixth financial instruments over the safety margin as depicted by cell 876 for third and fourth financial instruments may be considered as a result of the difference in strike prices between fifth/sixth financial instruments and third/fourth financial instruments. A decrease in the between spread as indicated by cell 883 may be experienced as result of the increase in safety margin for fifth/sixth financial instruments over third/fourth financial instruments. A decrease in the net spread as represented by cell 884, in the incremental percent return as represented by cell 886, in the potential percent net return as represented by cell 887 and in the potential percent annual return as represented by cell 888 may also be experienced as a result of the increase in safety margin for fifth/sixth financial instruments over third/fourth financial instruments.

Cell 891 may operate to present a much larger days-to-expiration for a seventh financial instrument as compared to first through sixth financial instruments. The between spread for seventh/eight financial instruments as represented by cell 892 may be considered much larger, as a result of the much larger days-to-expiration for seventh/eighth financial instruments over first through sixth financial instruments. The increase in the net spread as presented by cell 893, in the incremental percent return as presented by cell 894 and in the potential percent net return as presented by cell 896 may also be considered as a result of the much larger days-to-expiration for seventh/eight financial instruments over first through sixth financial instruments. The decrease in the potential percent annual return as presented by cell 897 may also be considered as a result of the much larger days-to-expiration for seventh/eight financial instruments over first and second financial instruments.

A user with a current investment position as denoted by the information in first financial instrument row 826 and second financial instrument row 827 may seek to analyze potential replacement positions. For example, a user may consider the current investment position in danger of sustaining a loss and may desire to replace the current investment position with a replacement investment position. A user may operate to view potential positions as illustrated in potential positions portion 803. Furthermore, a user may operate to add or remove new positions for analysis to potential positions portion 803.

For example, a user may seek to replace current investment position as illustrated in current position portion 802 with potential positions as denoted by third financial instrument row 871 and fourth financial instrument row 872. For example, a user may denote that by replacing the current position with a replacement position as denoted by third financial instrument row 871 and fourth financial instrument row 872, the potential percent net return of “7.9%” as denoted by cell 880 is the same as for the current position. Furthermore, by replacing the current position with the potential position as denoted by third financial instrument row 871 and fourth financial instrument row 872, a user may increase the safety margin by “2.9%” as denoted by cell 876. However, the potential percent annual return of “48.0%” is approximately half of the present potential annual return of “96.1%” as denoted by cell 859. Even though a user may increase the safety margin as desired, the significant decrease in potential annualized return may not be desirable. As a result, a user may opt to analyze other potential positions for replacement of current position.

For example, a user may opt to selection the potential position as related to the potential percent annual return of “56.0%” as denoted by cell 897. This potential position may experience an increase in potential percent net return of “18.4%” as denoted by cell 896 while also experiencing a moderate potential percent annual return of “56.0%” which a user may find desirable.

Referring back to FIG. 2H, at step 255, a user may seek to modify parameters of the presented information. For example, a user may choose to modify the buy bid-ask ratio. Using an interface such as shown in FIG. 8B, a user may view, configure, and analyze a current position in conjunction with potential positions to determine appropriate potential positions for replacing the current position. Generally, FIG. 8B depicts a user interface that comprises many of the same elements as are described in connection with FIG. 8A. These elements operate similarly as described above.

In the example scenario of FIG. 8B, buy bid-ask control 805 and sell bid-ask control 806 have been configured for a setting of 25%. A value for buy bid-ask control 805 of 25% indicates calculations performed and displayed for purchasing an option may be represented as 25% closer in value to the bid price of the option than to the ask price of an option. For example, for first financial instrument with financial instrument description as indicated by cell 833, the calculation and display of the between price of cell 838, presented as “0.8”, may be calculated as 25% of the distance between the bid price of cell 836, presented as “0.5” and the ask price of cell 837, presented as “1.5”. Furthermore, the calculation may be illustrated as (bid price+(ask price-bid price)*buy bid-ask control), calculated as (0.5+(1.5−0.5)*25%) which equals 0.75 for this example (or 0.8 with rounding). A value for sell bid-ask control 806 of 25% indicates calculations performed and displayed for selling an option may be represented as 25% closer in value to the ask price of the option than to the bid price of an option. For example, for second financial instrument with financial instrument description as indicated by cell 846, the calculation and display of the between price of cell 851, presented as “3.5”, may be calculated as 25% of the distance between the ask price of cell 849, presented as “4” and the bid price of cell 848, presented as “2”. Furthermore, the calculation may be illustrated as (ask price−(ask price-bid price)*sell bid-ask control), calculated as (4-(4-2)*25%) which equals 3.5 for this example.

In an example scenario, with buy bid-ask control 805 and sell bid-ask control 806 configured for 25%, the between price as denoted by “0.8” for cell 838 and the between price as denoted by “3.5” for cell 851 are significantly different than as denoted by “1” and “3”, for FIG. 8A, respectively. Furthermore, with buy bid-ask control 805 and sell bid-ask control 806 configured for 25% as illustrated in FIG. 8B, other display parameters are also significantly different as compared to FIG. 8A. For example, current percent gain-loss as denoted by cell 857 is denoted as “−2.6%” for FIG. 8A and as “−6.6%” for FIG. 8B. This difference may be contributed to potentially receiving different trade execution prices with respect to the range between bid and ask prices.

Furthermore, parameters for replacing a current position with potential positions are also significantly different from FIG. 8A to FIG. 8B as a result of a different configuration for buy bid-ask control 805 and sell bid-ask control 806. For example, the potential percent annual return as represented by cell 897 is denoted as “28.0%” for FIG. 8B and “56.0%” for FIG. 8A with this significant different attributed to potentially receiving different trade execution prices with respect to the range between bid and ask prices.

Referring back to FIG. 2H, at step 256, it may be determined whether user finds a suitable position for management. If a suitable position for management is not found, at step 257, a user may add additional positions for analysis. Processing continues at step 254.

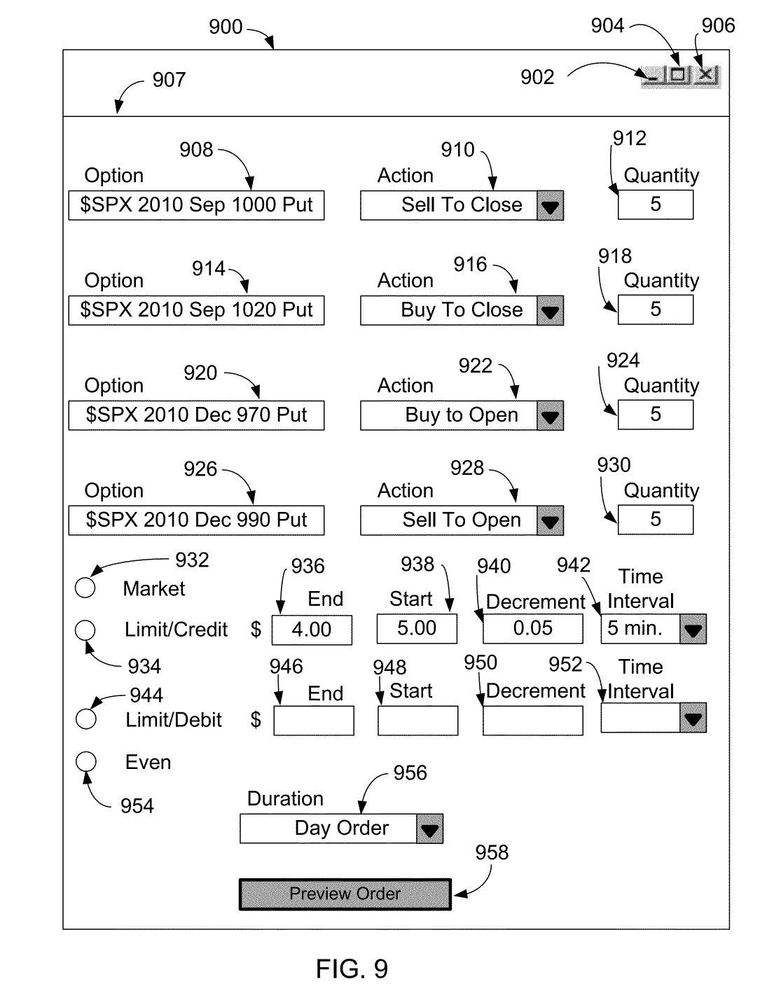

If at step 256, a user located a suitable position for management, at step 258, a user may select a suitable position for trading. The server communicates a display for defining the desired trade. An example user interface that may be used is represented by a display 900 illustrated in FIG. 9. Example display 900 illustrates a mechanism for a user to view, modify and configure information related to a potential trade execution for replacing a current position including the capability to configure a trade execution for automatic limit price modification.

A trade entry portion 907 includes a first financial instrument information portion 908, a first financial instrument action portion 910, a first financial instrument quantity portion 912, a second financial instrument information portion 914, a second financial instrument action portion 916, a second financial instrument quantity portion 918, a third financial instrument information portion 920, a third financial instrument action portion 922, a third financial instrument quantity portion 924, a fourth financial instrument information portion 926, a fourth financial instrument action portion 928, a fourth financial instrument quantity portion 930, a market selection 932, a limit-credit selection 934, an end price portion 936, a start price portion 938, a price decrement portion 940, a time interval portion 942, a limit-debit selection 944, an end price portion 946, a start price portion 948, a price increment portion 950, a time interval portion 952, an even selection 954, a trade duration portion 956 and a preview order button 958.

Trade entry portion 907 may operate to present information and receive input for performing trading of financial instruments. First financial instrument information portion 908 may operate to present and receive information related to a first financial instrument. Non-limiting examples of information first financial instrument information portion 908 may present and receive include underlying financial instrument, year of expiration, month of expiration, strike price and financial instrument type. First financial instrument action portion 910 may operate to present and receive information for the types of operations which may be performed for first financial instrument. Non-limiting examples for the types of operations which may be performed for a financial instrument include Sell-to-Close (STC), Buy-to-Close (BTC), Buy-to-Open (BTO) or Buy-to-Close (BTC). First financial instrument quantity portion 912 may operate to present and receive information related to the quantity of first financial instrument to be traded.

Second financial instrument information portion 914 may operate to present and receive information related to a second financial instrument. Non-limiting examples of information second financial instrument information portion 914 may present and receive include underlying financial instrument, year of expiration, month of expiration, strike price and financial instrument type. Second financial instrument action portion 916 may operate to present and receive information for the types of operations which may be performed for second financial instrument. Non-limiting examples for the types of operations which may be performed for a financial instrument include STC, BTC, BTO or BTC. Second financial instrument quantity portion 918 may operate to present and receive information related to the quantity of second financial instrument to be traded.

Third financial instrument information portion 920 may operate to present and receive information related to a third financial instrument. Non-limiting examples of information third financial instrument information portion 920 may present and receive include underlying financial instrument, year of expiration, month of expiration, strike price and financial instrument type. Third financial instrument action portion 922 may operate to present and receive information for the types of operations which may be performed for third financial instrument. Non-limiting examples for the types of operations which may be performed for a financial instrument include STC, BTC, BTO or BTC. Third financial instrument quantity portion 924 may operate to present and receive information related to the quantity of second financial instrument to be traded.

Fourth financial instrument information portion 926 may operate to present and receive information related to a fourth financial instrument. Non-limiting examples of information fourth financial instrument information portion 926 may present and receive include underlying financial instrument, year of expiration, month of expiration, strike price and financial instrument type. Fourth financial instrument action portion 928 may operate to present and receive information for the types of operations which may be performed for fourth financial instrument. Non-limiting examples for the types of operations which may be performed for a financial instrument include STC, BTC, BTO or BTC. Fourth financial instrument quantity portion 930 may operate to present and receive information related to the quantity of second financial instrument to be traded.

Market selection 932, limit-credit selection 934, limit-debit selection 944 and even selection 954 may operate for a user to select price information related to trading first financial instrument and second financial instrument. One of market selection, limit-credit selection 934, limit-debit selection 944 and even selection 954 may be selected during any given period of time. Market selection 932 may operate to indicate performance of a trade at market prices. Limit-credit selection 934 may operate to indicate performance of a trade with a minimum net credit. Limit-debit selection 944 may operate to indicate performance of a trade with a maximum net debit. Even selection 954 may operate to indicate a trade may be performed for with no additional net credit or net debit.

End price portion 936 may operate to present and receive information related to an ending or last price for limit-credit selection 934. Start price portion 938 may operate to present and receive information related to a starting or beginning price for limit-credit selection 934. Price decrement portion 940 may operate to present and receive information related to decrementing a price associated with limit-credit selection 934. Time interval portion 942 may operate to present and receive information related to a time interval for decrementing a price associated with limit-credit selection 934 and with price decrement portion 940.

End price portion 946 may operate to present and receive information related to an ending or last price for limit-debit selection 944. Start price portion 948 may operate to present and receive information related to a starting or beginning price for limit-debit selection 944. Price increment portion 950 may operate to present and receive information related to incrementing a price associated with limit-debit selection 944. Time interval portion 952 may operate to present and receive information related to a time interval for incrementing a price associated with limit-debit selection 944 and with price increment portion 950.

Trade duration portion 956 may operate to present and receive information related to the duration of a trade. Non-limiting examples for duration of trade include day order and good until canceled. Preview order button 958 may operate to enable preview of a financial instrument order prior to submission for execution.

Referring back to FIG. 2, at step 259, server (e.g. server device 108 (FIG. 1)) may receive trade selection information.

At step 261, server (e.g. server device 108 (FIG. 1)) may perform calculations for performing trade execution.

At step 262, server (e.g. server device 108 (FIG. 1)) may present trade information to the user.

At step 263, the user may select preview order button 958 followed by selecting to trade position in order to initiate trade with broker.

At step 264, a trade may be posted with a broker for execution. At step 266, the trade is executed.

At step 267, server (e.g. server device 108 (FIG. 1)) receives the results from the trade execution.

At step 268, server (e.g. server device 108 (FIG. 1)) may store information associated with the trade execution. Non-limiting examples for storing information associated with trade execution include memory, hard disk, database and portfolio database.

At step 269, it may be determined whether the user seeks to manage additional positions. If so, execution proceeds at step 247 (FIG. 2G). If it is determined that the user does not wish to manage additional positions, processing continues at step 271.

At step 271, the system determines whether the user wishes to perform an analysis of a portfolio under various different assumptions. For example, the system determines whether a user input is received indicating the user desires to evaluate positions under various assumptions as to future price movements. If no such request is received, processing waits for further user input.

However, if at step 271 input is received indicating an interest in evaluating a position under various assumptions regarding potential future conditions, at step 273, processing proceeds at step 273.

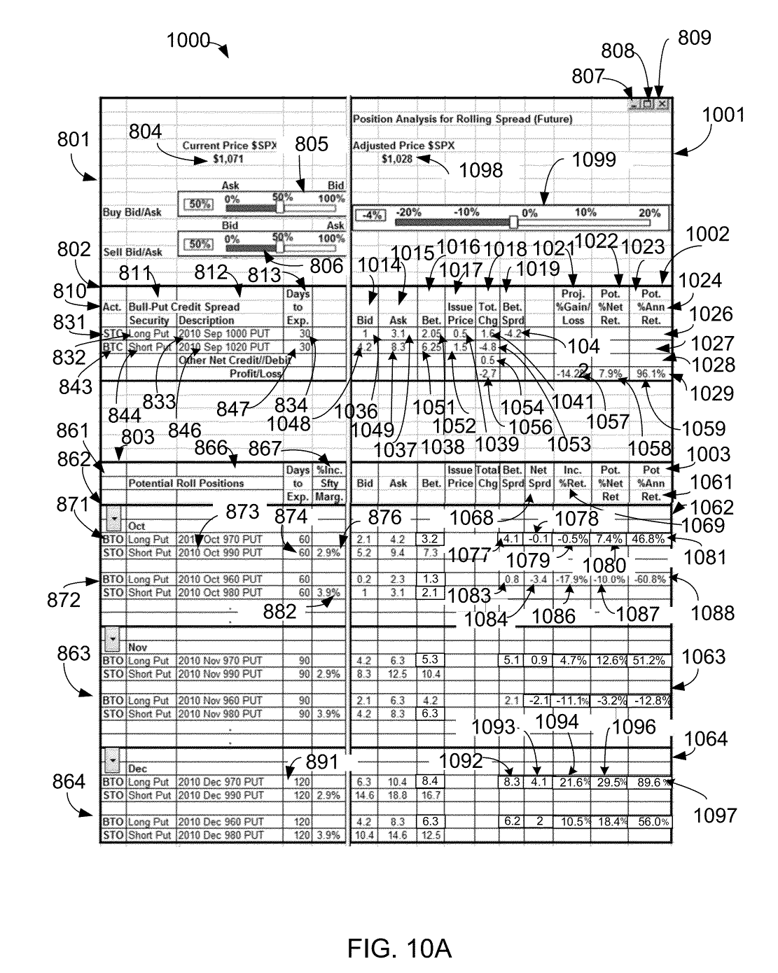

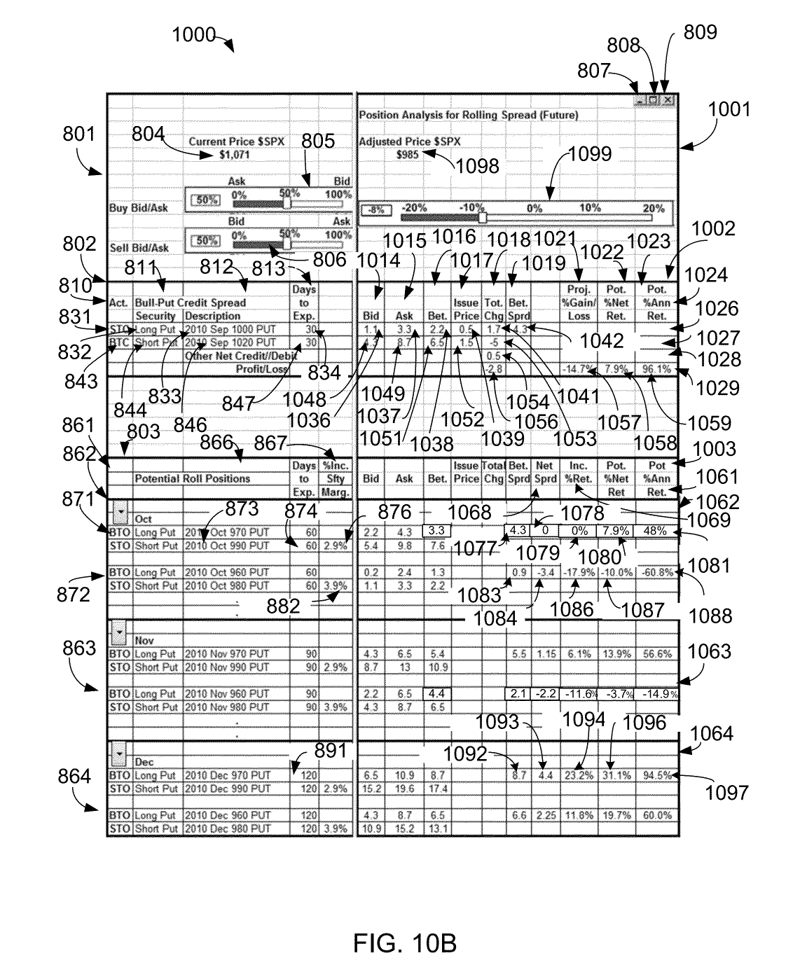

At step 273, the server (e.g. server device 108 (FIG. 1)) retrieves information associated with a selected position. At step 274, the server (e.g. server device 108 (FIG. 1)) performs scenario calculations and presents information to a user as described with reference to FIG. 10A. FIG. 10A illustrates a mechanism for a user to view, configure and analyze a current position in conjunction with hypothetical potential positions to determine appropriate estimated potential positions for replacing the current position. Furthermore, FIG. 10A illustrates a mechanism for a user to select a hypothetical potential position for trade execution for replacing the current position.

FIG. 10A illustrates an example display that is similar to and contains many of the same or similar elements as those disclosed in connection with FIG. 8A. It will be appreciated that those elements operate similarly in connection with FIG. 10A as they did in connection with FIG. 8A.

Referring to FIG. 10A, an information display 1000 includes information and control portion 801, current position portion 802, potential positions portion 803, an information and control portion 1001, a current position estimated portion 1002 and a potential positions estimated portion 1003.

Current position estimated portion 1002 includes a estimated bid price column 1014, an estimated ask price column 1015, an estimated between price column 1016, an issue price column 1017, an estimated total price change column 1018, an estimated between spread price column 1019, an estimated projected percent gain-loss column 1021, an projected potential percent net return column 1022, a projected potential percent annual return column 1023, a header row 1024, a first financial instrument row 1026, a second financial instrument row 1027, an other net credit-debit row 1028 and a profit-loss row 1029.

A cell 1036 indicates an estimated bid price of “1” for first financial instrument. A cell 1037 indicates an estimated ask price of “3.1” for first financial instrument. A cell 1038 indicates an estimated between price of “2.05” for first financial instrument. A cell 1039 indicates an issue price of “0.5” for first financial instrument. A cell 1041 indicates an estimated total price change of “1.6” for first financial instrument. A cell 1042 indicates an estimated between spread price of “4.2” for first financial instrument and second financial instrument.

A cell 1048 indicates an estimated bid price of “4.2” for second financial instrument. A cell 1049 indicates an estimated ask price of “8.3” for second financial instrument. A cell 1051 indicates an estimated between price of “6.25” for second financial instrument. A cell 1052 indicates an issue price of “1.5” for second financial instrument. A cell 1053 indicates an estimated total price change of “−4.8” for second financial instrument.

A cell 1054 indicates an other net credit-debit of “0.5”. A cell 1056 indicates an estimated profit-loss of “−2.7” for current position. A cell 1057 indicates an estimated projected percent gain-loss of “−14.2%” for current position. A cell 1058 indicates a potential percent net return of “7.9%” for current position. A cell 1059 indicates an estimated potential percent annual return of “96.1%” for current position.

Header row 1024 may operate to describe elements depicted below header row 1024. First financial instrument row 1026 may operate to depict estimated information related to a first financial instrument. Non-limiting examples of information first financial instrument row 1026 may depict include trade activity, type of financial instrument, description of financial instrument, days-to-expiration, bid price, ask price, between price, issue price, total price change and between spread price. Second financial instrument row 1027 may operate to depict information related to a second financial instrument. Non-limiting examples of information second financial instrument row 1027 may depict include trade activity, type of financial instrument, description of financial instrument, days-to-expiration, bid price, ask price, between price, issue price, total price change and between spread price.

Other net credit-debit row 1028 may operate to depict information related to other related net credits or net debits. Non-limiting examples of other net credits or net debits include closing a portion of a position, opening a new position and rolling a position. Profit-loss row 1029 may operate to present an estimated total profit and loss with respect to first financial instrument, second financial instrument and/or other related net credits or net debits. Non-limiting examples of information depicted by profit-loss row 1029 include total price change profit/loss, current percentage profit/loss, potential percentage profit/loss and potential percentage annualized profit/loss.

Potential positions estimated portion 1003 includes a header row portion 1061, a first potential month portion 1062, a second potential month portion 1063 and a third potential month portion 1064. Header row portion 1061 includes columns as depicted for header row 1024 plus an estimated net spread price column 1068 and an estimated incremental percent return column 1069.

Second potential month portion 1063 may operate to present estimated information related to potential positions for rolling position associated with current position portion 802.

Third potential month portion 1064 may operate to present estimated information related to potential positions for rolling position associated with current position portion 802.

For first potential month portion 1062, a cell 1077 indicates an estimated between spread price of “4.1” for third and fourth financial instruments. A cell 1078 indicates an estimated net spread price of “−0.1” for third and fourth financial instruments. A cell 1079 indicates an estimated incremental percent return of “−0.5%” for third and fourth financial instruments. A cell 1080 indicates an estimated potential percent net return of “7.4%” for third and fourth financial instruments. A cell 1081 indicates an estimated potential percent annual return of “46.8%” for third and fourth financial instruments.

A cell 1083 indicates an estimated between spread price of “0.8” for fifth and sixth financial instruments. A cell 1084 indicates an estimated net spread price of “−3.4” for fifth and sixth financial instruments. A cell 1086 indicates an estimated incremental percent return of “−17.9%” for fifth and sixth financial instruments. A cell 1087 indicates an estimated potential percent net return of “−10.0%” for fifth and sixth financial instruments. A cell 1088 indicates an estimated potential percent annual return of “−60.8%” for fifth and sixth financial instruments.

For third potential month portion 1064, a cell 1092 indicates an estimated between spread price of “8.3” for seventh and eighth financial instruments. A cell 1093 indicates an estimated net spread price of “4.1” for seventh and eighth financial instruments. A cell 1094 indicates an estimated incremental percent return of “21.6%” for seventh and eighth financial instruments. A cell 1096 indicates an estimated potential percent net return of “29.5%” for seventh and eighth financial instruments. A cell 1097 indicates an estimated potential percent annual return of “89.6%” for seventh and eighth financial instruments.

Information and control portion 1001 may operate to display information and enable adjustment or modification of parameters. An adjusted price control 1099 may operate to modify the value of an adjusted price display 1098. In the example scenario that is depicted, for a value of −4% for adjusted price control 1099, the value of adjusted price display 1098 may be presented as $1,028. The calculation for adjusted price display 1098 may be represented as (current price*(1+adjusted price control)) or (current price display 804*(1+value of adjusted price control 1099)).

Current position estimated portion 1002 may operate to present estimated information for a current position with an adjusted price as controlled by adjusted price control 1099 and as displayed by adjusted price display 1098. Any known algorithm for estimating an adjusted price may be used for information presented via current position estimated portion 1002.

Estimated bid price column 1014 may operate to present an estimated bid price for a listed financial instrument. Estimated bid price may operate to represent the estimated market price for which a financial instrument may be sold. Estimated ask price column 1015 may to present the estimated ask price for a listed financial instrument. Estimated ask price may operate to represent an estimated market price for which a financial instrument may be purchased. Estimated between price column 1016 may operate to present an estimated price calculated between the bid price and ask price for a financial instrument. The calculation for estimated between price column 1016 for a financial instrument for sale may be represented as (estimated bid price+(estimated ask price−estimated bid price)*(value of sell bid-ask control 806)). The calculation for estimated between price column 1016 for a financial instrument for purchase may be represented as (estimated bid price+(estimated ask price−estimated bid price)*(value of buy bid-ask control 805)). Issue price column 1017 may operate to present the sale or purchase price for an existing investment position. Estimated total price change column 818 may operate to present an estimated price change as related to the issue price for an existing position and with respect to the between price for the financial instrument. For a purchased or long financial instrument, estimated total price change column 1018 may be calculated as (estimated price between−issue price). For a sold or short financial instrument, estimated total price change column 1018 may be calculated as (issue price−estimated between price). Estimated between spread price column 1019 may operate to present an estimated difference between a price between for a purchased or long financial instrument and a sold or short financial instrument. Estimated between spread price column 1019 may be calculated as (estimated price between long position−estimated price between short position). Estimated projected percent gain-loss column 1021 may operate to present an estimated percentage gain or loss for an existing position with respect to exiting the position and receiving estimated pricing with respect to the price between bid and ask for the respective financial instruments. Projected potential percent net return column 1022 may operate to present a projected potential return for an investment position with conditions as related to adjusted price control 1099. Projected potential percent annual return column 1023 represents an estimated annualized return for an investment position with conditions for a favorable outcome.

Potential positions estimated portion 1003 may operate to present information related to rolling or management of a position with respect to estimated pricing based on adjusted price control 1099.

Estimated net spread price column 1068 may operate to represent an estimated net spread for rolling or managing a position. A positive value for a value in estimated net spread price column 1068 may indicate additional potential return may be realized after position management, a negative value for a value in estimated net spread price column 1068 may indicate less potential return may be realized after position management and a zero value for a value in estimated net spread price column 1068 may indicate the potential return after position management remains unchanged from the prior position. Estimated incremental percent return column 1069 may operate to represent an estimated incremental percent return for a position after position management. A positive value for a value in estimated incremental percent return column 1069 may indicate additional potential return may be realized after position management, a negative value in estimated incremental percent return column 1069 may indicate decreased potential return may be realized after position management and a zero value in estimated incremental percent return column 1069 may indicate the potential return after position management remains unchanged from the prior position.

A user with a current investment position as denoted by the information in first financial instrument row 826 and second financial instrument row 827 may seek to analyze potential replacement positions based upon a hypothetical price movement for a security. For example, a user may consider the current investment position in danger of sustaining a loss and may desire to replace the current investment position with a replacement investment position. Furthermore, the user may seek to analyze replacement of a current position based upon hypothetical pricing. A user may operate to view hypothetical potential positions as illustrated in potential positions estimated portion 1003. Furthermore, a user may operate to add or remove new positions for analysis to potential positions estimated portion 1003.

For example, a user may seek to replace current investment position as illustrated in current position portion 802 with potential positions as denoted by third financial instrument row 871 and fourth financial instrument row 872. For example, a user may denote that by replacing the current position with a replacement position as denoted by third financial instrument row 871 and fourth financial instrument row 872, the potential percent net return of “7.4%” as denoted by cell 1080 is similar as for the current position. Furthermore, by replacing the current position with the potential position as denoted by third financial instrument row 871 and fourth financial instrument row 872, a user may increase the safety margin by “2.9%” as denoted by cell 876. However, the potential percent annual return of “46.8%” as denoted by cell 1081 is approximately half of the present potential annual return of “96.1%” as denoted by cell 1059. Even though a user may increase the safety margin as desired, the significant decrease in annualized return may not be desirable. As a result, a user may opt to analyze other potential positions for replacement of current position.

For example, a user may opt to select the potential position as related to the potential percent annual return of “89.6%” as denoted by cell 1097. This potential position may experience an increase in potential percent net return of “29.5%” as denoted by cell 1096 while also experiencing an attractive potential percent annual return of “89.6%” which a user may find desirable.

Referring back to FIG. 2K, at step 276, a user may operate to modify parameters associated with scenario analysis as described with reference to FIG. 10B. FIG. 10B illustrates a mechanism for a user to view, configure and analyze a current position in conjunction with hypothetical potential positions to determine appropriate hypothetical potential positions for replacing the current position. Elements of FIG. 10B in common with FIG. 10A described previously will not be described with reference to FIG. 10B.

Referring to FIG. 10B, the value for adjusted price control 1099 has been modified to −8% versus the value of −4% as discussed with reference to FIG. 10A. Adjusted price display 1098 indicates an adjusted price of “$985” as a result of adjusted price control 1099 being configured to −8%. The adjusted price of “$985” for adjusted price display 1098 may operate to represent a −8% change in the price of $1,071 as denoted for current price display 804.

The value displayed for the estimated bid price for first security as denoted by cell 1036, the estimated ask price for first security as denoted by cell 1037, the estimated bid price for second security as denoted by cell 1048 and the estimated ask price for second security as denoted by cell 1049 are calculated based upon the value configured for adjusted price control 1099. The calculations performed for cell 1036, cell 1037, cell 1048 and cell 1049 may be any know algorithm for performing financial instrument estimates. Non-limiting examples of algorithms for performing financial instrument estimates include Black-Scholes and Binomial.

Modification of adjusted price control 1099 enables a user to analyze potential trades for repositioning based upon hypothetical prices for financial instruments.

Referring to FIG. 2K, at step 277, a determination is made as to whether to add a position based upon the information discerned using FIG. 10. For a determination of not finding a suitable position at step 278, a new position may be added. However, if a suitable position is located, processing may continue at step 258.

### Example Computing Environment

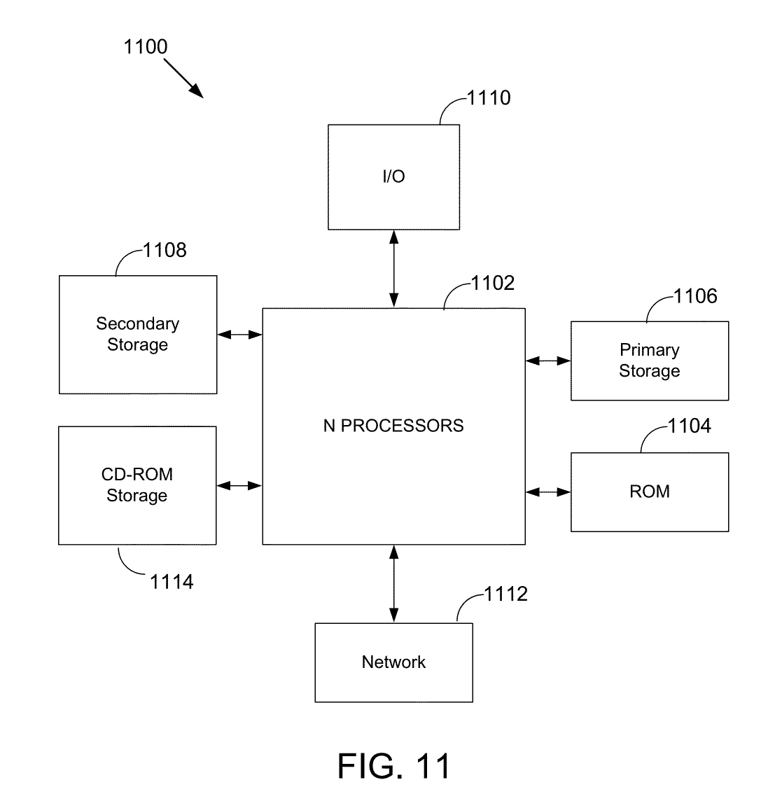

FIG. 11 depicts a block diagram of an exemplary computing system 1100 that may be used to implement the systems and methods described herein. For example, the computing system 1100 may be used to implement the server devices 108 and 110 as well as any other computing devices including networking devices 120 and 122. The computing system 1100 may be controlled primarily by computer readable instructions that may be in the form of software. The computer readable instructions may include instructions for the computing system 1100 for storing and accessing computer readable instructions themselves. Such software may be executed within a processing unit (CPU) 1102 to cause the computing system 1100 to perform the processes or functions associated therewith. In many known computer servers, workstations, personal computers, or the like, the computing system 1100 may be implemented by micro-electronic chips CPUs called microprocessors.

In operation, CPU 1102 may fetch, decode, and/or execute instructions and may transfer information to and from other resources via a main data-transfer path or a system bus to a network 1112. Such a system bus may connect the components in the computing system 1100 and may define the medium for data exchange. The computing system 1100 may further include memory devices coupled to the system bus. According to an example embodiment, the memory devices may include a primary storage 1106, a secondary storage 1108, a CD-ROM storage 1114, and a ROM 1104. Access to memory may be controlled by a memory controller. The memory controller may provide an address translation function that translates virtual addresses into physical addresses as instructions are executed.

In addition, the computing system 1100 may include various I/O devices 1110. The I/O devices may be any type that is needed to operate the system. For example I/O devices may comprise peripherals, such as, a printer 1040, a keyboard 1045, a mouse 1050, and data a storage drive 1055. The computing system 1100 may further include a display that may be controlled by a display controller. The display may be used to display visual output generated by the computing system 1100. Such visual output may include text, graphics, animated graphics, video, or the like. The display controller may include electronic components that generate a video signal that may be sent to the display. Further, the computing system 1100 may include a network adaptor 1112 that may be used to connect the computing system 1100 to an external communication network such as any of the networks described above in connection with FIG. 1.

Thus, applicants have disclosed exemplary embodiments of systems and methods for financial position analysis using optionmidrange spread values. It will be appreciated that while illustrative embodiments have been disclosed, the scope of potential embodiments is not limited to those explicitly set out. For example, while the system has been described with reference to particular user interface screens, the envisioned embodiments extend beyond any particular user interface format. Similarly, any type of device such as, for example, a laptop computer, PDA, mobile phone, etc. may be used to send or receive messages.

It should be understood that the various techniques described herein may be implemented in connection with hardware or software or, where appropriate, with a combination of both. Thus, the methods and apparatus of the subject matter described herein, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although example embodiments may refer to utilizing aspects of the subject matter described herein in the context of one or more stand-alone computer systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method implemented by a computing system for processing financial instrument data, the method comprising:
a computing system receiving financial data from at least one data source, the financial data comprising data relating to a plurality of financial instruments;
the computing system maintaining the financial data in a database;
the computing system deriving using the financial data for a first financial instrument in the plurality of financial instruments a first midpoint value disposed between a bid price and an ask price;
the computing system deriving using the financial data for a second financial instrument in the plurality of financial instruments a second midpoint value disposed between a bid price and an ask price;
the computing system communicating identifying information for the first financial instrument for display, the identifying information for the first financial instrument comprising the first midpoint value;
the computing system communicating identifying information for the second financial instrument for display, the identifying information for the second instrument comprising the second midpoint value;
the computing system deriving from the first and second midpoint values a spread value representing the difference between the first and second midpoint values; and
the computing system communicating said spread value for display.

2. The method of claim 1, further comprising:
maintaining midpoint values for each of the plurality of financial instruments in the database; and
maintaining the derived said spread value in the database.

3. The method of claim 1, wherein the financial instruments are options.

4. The method of claim 1,
wherein communicating identifying information for the first financial instrument comprises communicating for the first financial instrument a first strike price, a first bid price, a first ask price, and the first midpoint value, and
wherein communicating identifying information for the second financial instrument comprises communicating for the second financial instrument a second strike price, a second bid price, a second ask price, and the second midpoint value.

5. The method of claim 4, further comprising:
receiving an input indicating selection of said spread value; and
in response to receiving the input, communicating an instruction to emphasize on a display the said displayed spread value, the first strike price, the first bid price, the first ask price, the first midpoint value, the second strike price, the second bid price, the second ask price and the second midpoint value.

6. The method of claim 1, further comprising:
receiving an input identifying the said spread value and requesting to perform a trade;
communicating information identifying the first financial instrument, a first trade action, and a first trade quantity; and
communicating information identifying the second financial instrument, a second trade action, and a second trade quantity.

7. The method of claim 6, further comprising
receiving information identifying for the first financial instrument, a first trade action, and a first trade quantity;
receiving information identifying for the second financial instrument, a second trade action, and a second trade quantity;
receiving information selecting one of the following parameters for executing a trade: execute trade at market prices; execute trade with minimum net credit; execute trade with maximum net debit; and execute trade with no additional net credit or debit;
receiving information identifying an end price for a trade, a start price for a trade, a decrement value by which to decrement price; and a time interval over which to decrement the price.

8. The method of claim 6, further comprising
receiving information identifying for the first financial instrument, a first trade action, and a first trade quantity;
receiving information identifying for the second financial instrument, a second trade action, and a second trade quantity;
receiving information selecting one of the following parameters for executing a trade: execute trade at market prices; execute trade with minimum net credit; execute trade with maximum net debit; and execute trade with no additional net credit or debit; and
receiving information identifying an end price for a trade, a start price for a trade, an increment value by which to increment price; and a time interval over which to increment the price.

9. The method of claim 7, further comprising communicating a series of trade requests, the first in the series of trade requests requesting a trade at the start price and each successive request requesting a trade less than the previous trade by the decrement price.

10. The method of claim 8, further comprising communicating a series of trade requests, the first in the series of trade requests requesting a trade at the start price and each successive request requesting a trade greater than the previous trade by the increment price.

11. The method of claim 8, further comprising halting communicating a series of trade requests at the end price.

12. The method of claim 10, further comprising halting communicating a series of trade requests at the end price.

13. The method of claim 5,
wherein said selected spread value is selectable for performing trade execution;
presenting for display the first financial instrument, an associated first financial instrument action, and first financial instrument quantity;
presenting for display the second financial instrument, an associated second financial instrument action, and second financial instrument quantity;
presenting for display a market trade selection, a credit selection, a debit selection, and an even selection;
presenting for display a credit end price, a credit start price, a credit decrement price, and a credit time interval associated with said credit selection; and
presenting for display a debit end price, a debit start price, a debit increment price, and a debit time interval associated with said debit selection.

14. The method of claim 13,
wherein said first financial instrument, said first financial instrument action, said first financial instrument quantity, said second financial instrument, said second financial instrument action, said second financial instrument quantity, said market selection, said credit selection, said debit selection, said even selection, said credit end price, said credit start price, said credit decrement price, said credit time interval, said debit end price, said debit start price, said debit increment price and said debit time interval may be modified.

15. The method of claim 13,
initiating a trade execution at a credit price associated with said credit start price;
decrementing said credit price by said credit decrement price at intervals of time governed by said credit time interval; and
decrementing said credit price by said credit decrement price until said trade execution is completed or until said credit price equals said credit end price.

16. The method of claim 13,
initiating a trade execution at debit price associated with said debit start price;
incrementing said debit price by said debit increment price at intervals of time governed by said debit time interval; and
incrementing said debit price by said debit increment price until said trade execution is completed or until said debit price equals said debit end price.

17. The method of claim 15,
wherein an initial end price for said credit end price equals the difference between midpoint values derived for said second financial instrument midpoint value subtracted from said first financial instrument midpoint value;
wherein a first financial instrument market price equals first financial instrument ask price;
wherein a second financial instrument market price equals second financial instrument bid price; and
wherein an initial start price for said credit start price equals said second financial instrument market price subtracted from said first financial instrument market price.

18. The method of claim 16,
wherein an initial end price for said debit end price equals the difference between midpoint values derived for said first financial instrument midpoint value subtracted from and said second financial instrument midpoint value;
wherein a first financial instrument market price equals first financial instrument bid price;
wherein a second financial instrument market price equals second financial instrument ask price; and
wherein an initial start price for said debit start price equals said first financial instrument market price subtracted from said second financial instrument market price.

19. A method implemented by a computing system for processing financial data, comprising:
a computing system receiving financial data from at least one data source, the financial data comprising data relating to a plurality of financial instruments;
the computing system maintaining the financial data in a database;
the computing system identifying using the financial data a first spread comprising a first financial instrument and a second financial instrument comprised in the plurality of financial instruments, the first spread having a first strike differential representing a difference in strike prices between the first financial instrument and the second financial instrument;
the computing system deriving using the financial data for the first financial instrument a first midrange value disposed between a bid price and an ask price;
the computing system deriving using the financial data for the second financial instrument a second midrange value disposed between a bid price and an ask price;
the computing system deriving from the first and second midrange values a first spread midrange difference value representing a difference between the first and second midrange values;
the computing system deriving a first strike price differential representing a difference between a strike price for the first financial instrument and a strike price for the second financial instrument;
the computing system searching using the financial data for spreads with a strike price differential somewhat similar or less than or greater than the first strike price differential;
identifying at least a second spread with a strike price differential similar or somewhat less than or somewhat greater than the first strike price differential, the at least a second identified spread comprising a third financial instrument and a fourth financial instrument;
the computing system deriving using the financial data for the third financial instrument a third midrange value disposed between a bid price and an ask price;
the computing system deriving using the financial data for the fourth financial instrument a fourth midrange value disposed between a bid price and an ask price;
the computing system deriving from the third and fourth midrange values a second spread midrange difference value representing a difference between the third and fourth midrange values;
the computing system communicating identifying information for the first spread for display, the identifying information comprising identifying information for the first financial instrument including the first midrange value, identifying information for the second financial instrument including the second midrange value for display by the computing system, and information identifying the first spread midrange difference value; and
the computing system communicating identifying information for the second spread for display, the identifying information comprising identifying information for the third financial instrument including the third midpoint value, identifying information for the fourth financial instrument including the fourth midpoint value for display by the computing system, and information identifying the second spread midrange difference value.

20. The method of claim 19,
wherein deriving using the financial data for the first financial instrument a first midrange value disposed between a bid price and an ask price comprises deriving a percentage of a range disposed between a current bid price and a current ask price; and
wherein deriving using the financial data for the second financial instrument a second midrange value disposed between a bid price and an ask price comprises deriving a percentage of a range disposed between a current bid price and a current ask price.

21. The method of claim 19,
wherein deriving using the financial data for the third financial instrument a third midrange value disposed between a bid price and an ask price comprises deriving a percentage of a range disposed between a current bid price and a current ask price; and
wherein deriving using the financial data for the fourth financial instrument a fourth midrange value disposed between a bid price and an ask price comprises deriving a percentage of a range disposed between a current bid price and a current ask price.

22. The method of claim 19, further comprising:
the computing system deriving for the second spread a net spread value from the first spread midrange difference value and the second spread midrange difference value.

23. The method of claim 22, wherein deriving a net spread value from the first spread midrange difference value and the second spread midrange difference value comprises adding the first spread midrange difference value and the second spread midrange difference value.

24. The method of claim 22, further comprising:
the computing system deriving an incremental potential percent return using the derived net spread value and a measurement of money invested in converting the first spread to the second spread.

25. The method of claim 24, further comprising:
the computer system deriving for the second spread a potential percent net return using a potential return for the first spread and the derived incremental potential percent return.

26. The method of claim 25, further comprising:
the computer system deriving for the second spread an annualized potential percent net return using a potential return for the first spread and the derived incremental potential percent return.

27. The method of claim 19, further comprising:
maintaining midpoint values for each of the plurality of financial instruments in the database; and
maintaining the derived spread value in the database.

28. The method of claim 19, wherein the financial instruments are options.

29. The method of claim 19, further comprising:
receiving an input indicating the spread value has been selected; and
in response to receiving the input, communicating an instruction to emphasize on a display the displayed spread value, the first strike price, the first bid price, the first ask price, the first midpoint value, the second strike price, the second bid price, the second ask price and the second midpoint value.

30. The method of claim 19, further comprising:
receiving an input identifying the spread value and requesting to perform a trade;
communicating information identifying the first financial instrument; and
communicating information identifying the second financial instrument.

31. The method of claim 30, further comprising
receiving information identifying for the first financial instrument, a first trade action, and a first trade quantity;
receiving information identifying for the second financial instrument, a second trade action, and a second trade quantity;
receiving information selecting one of the following parameters for executing a trade: execute trade at market prices; execute trade with minimum net credit; execute trade with maximum net debit; and execute trade with no additional net credit or debit;
receiving information identifying an end price for a trade, a start price for a trade, a decrement value by which to decrement price; and a time interval over which to decrement the price.

32. The method of claim 30, further comprising
receiving information identifying for the first financial instrument, a first trade action, and a first trade quantity;
receiving information identifying for the second financial instrument, a second trade action, and a second trade quantity;
receiving information selecting one of the following parameters for executing a trade: execute trade at market prices; execute trade with minimum net credit; execute trade with maximum net debit; and execute trade with no additional net credit or debit;
receiving information identifying an end price for a trade, a start price for a trade, an increment value by which to increment price; and a time interval over which to increment the price.

33. The method of claim 31, further comprising communicating a series of trade requests, the first in the series of trade requests requesting a trade at the start price and each successive request requesting a trade less than the previous trade by the decrement price.

34. The method of claim 32, further comprising communicating a series of trade requests, the first in the series of trade requests requesting a trade at the start price and each successive request requesting a trade greater than the previous trade by the increment price.

35. The method of claim 33, further comprising halting communicating a series of trade requests at the end price.

36. The method of claim 34, further comprising halting communicating a series of trade requests at the end price.

37. The method of claim 19,
presenting for display a first financial instrument, an associated first financial instrument action, and first financial instrument quantity;
presenting for display a second financial instrument, an associated second financial instrument action, and a second financial instrument quantity;
presenting for display a third financial instrument, an associated third financial instrument action, and a third financial instrument quantity;
presenting for display a fourth financial instrument, an associated fourth financial instrument action, and a fourth financial instrument quantity;
presenting for display a market selection, a credit selection, a debit selection, and an even selection associated with said trade execution, said market selection, said credit selection, said debit selection and said even selection being selectable;
presenting for display a credit end price, a credit start price, a credit decrement price, and a credit time interval associated with said credit selection; and
presenting for display a debit end price, a debit start price, a debit increment price, and debit time interval associated with said debit selection.

38. The method of claim 37,
wherein said first financial instrument, said first financial instrument action, said first financial instrument quantity, said second financial instrument, said second financial instrument action, said second financial instrument quantity, said third financial instrument, said third financial instrument action, said third financial instrument quantity, said fourth financial instrument, said fourth financial instrument action, said fourth financial instrument quantity, said market selection, said credit selection, said debit selection, said even selection, said credit end price, said credit start price, said credit decrement price, said credit time interval, said debit end price, said debit start price, said debit increment price and said debit time interval may be modified based upon user input.

39. The method of claim 38,
initiating a trade at a credit price associated with said credit start price,
decrementing said credit price by said credit decrement price at intervals of time governed by said credit time interval, and
decrementing said credit price by said credit decrement price until said trade execution is completed or until said credit price equals said credit end price.

40. The method of claim 39,
wherein initial price for said credit end price equals selected net spread value derived from summation of said current spread value and said spread values for said third financial instrument and said fourth financial instrument,
wherein net market price is derived from market prices for said first financial instrument, said second financial instrument, said third financial instrument and said fourth financial instrument, and
wherein initial price for said credit end price equals said net market price.

41. The method of claim 38,
wherein said trade execution initiates at debit price associated with said debit start price,
wherein said debit price is incremented by said debit increment price at intervals of time governed by said debit time interval, and
wherein said debit price is incremented by said debit increment price until said trade execution is completed or until said debit price equals said debit end price.

42. The method of claim 41,
wherein net spread value is derived from summation of said current spread value and selected potential spread value for said third financial instrument and said fourth financial instrument,
wherein initial price for said debit start price equals said net spread value,
wherein net market price is derived from market prices for said first financial instrument, said second financial instrument, said third financial instrument and said fourth financial instrument, and
wherein initial price for said debit end price equals said net market price.

43. A method implemented by a computing system for processing financial data, comprising:
a computing system receiving financial data from at least one data source, the financial data comprising data relating to a plurality of financial instruments;
the computing system maintaining the financial data in a database;
the computing system identifying using the financial data a first spread comprising a first financial instrument and a second financial instrument comprised in the plurality of financial instruments, the first spread having a first strike differential representing a difference in strike prices between the first financial instrument and the second financial instrument;
identifying an estimated price movement for a financial instrument;
the computing system deriving, using the financial data for the first financial instrument and the estimated price movement, a first midrange value disposed between a bid price and an ask price;
the computing system deriving, using the financial data for the second financial instrument and the estimated price movement, a second midrange value disposed between a bid price and an ask price;
the computing system deriving from the first and second midrange values a first spread midrange difference value representing a difference between the first and second midrange values;
the computing system deriving a first strike price differential representing a difference between a strike price for the first financial instrument and a strike price for the second financial instrument;
the computing system searching using the financial data for spreads with a strike price differential similar, somewhat less than or somewhat greater than the first strike price differential;
identifying at least a second spread with a strike price differential similar, somewhat less than or somewhat greater than the first strike price differential, the at least a second identified spread comprising a third financial instrument and a fourth financial instrument;
the computing system deriving, using the financial data for the third financial instrument and the estimated price movement, a third midrange value disposed between an estimated bid price and an estimated ask price;
the computing system deriving, using the financial data for the fourth financial instrument and the estimated price movement, a fourth midrange value disposed between an estimated bid price and an estimated ask price;
the computing system deriving from the third and fourth midrange values a second spread midrange difference value representing a difference between the third and fourth midrange values;
the computing system communicating identifying information for the first spread for display, the identifying information comprising identifying information for the first financial instrument including the first midrange value, identifying information for the second financial instrument including the second midrange value for display by the computing system, and information identifying the first spread midrange difference value; and
the computing system communicating identifying information for the second spread for display, the identifying information comprising identifying information for the third financial instrument including the third midpoint value, identifying information for the fourth financial instrument including the fourth midpoint value for display by the computing system, and information identifying the second spread midrange difference value.

44. The method of claim 43,
wherein deriving using the financial data for the first financial instrument a first midrange value disposed between a bid price and an ask price comprises deriving a percentage of a range disposed between a current bid price and a current ask price; and
wherein deriving using the financial data for the second financial instrument a second midrange value disposed between a bid price and an ask price comprises deriving a percentage of a range disposed between a current bid price and a current ask price.

45. The method of claim 43,
wherein deriving using the financial data for the third financial instrument a third midrange value disposed between a bid price and an ask price comprises deriving a percentage of a range disposed between a current bid price and a current ask price; and
wherein deriving using the financial data for the fourth financial instrument a fourth midrange value disposed between a bid price and an ask price comprises deriving a percentage of a range disposed between a current bid price and a current ask price.

46. The method of claim 43, further comprising:
the computing system deriving for the second spread a net spread value from the first spread value and the second spread value.

47. The method of claim 46, wherein deriving a net spread value from the first spread value and the second spread value comprises adding the first spread value and the second spread value.

48. The method of claim 46, further comprising:
the computing system deriving an incremental percent return using the derived net spread value and a measurement of money invested in converting the first spread to the second spread.

49. The method of claim 48, further comprising:
the computer system deriving for the second spread a potential percent net return using a potential return for the first spread and the derived incremental potential percent return.

50. The method of claim 49, further comprising:
the computer system deriving for the second spread an annualized potential percent net return using a potential return for the first spread and the derived incremental potential percent return.

51. The method of claim 43, further comprising:
maintaining midpoint values for each of the plurality of financial instruments in the database; and
maintaining the derived spread value in the database.

52. The method of claim 43, wherein the financial instruments are options.
